(19) United States
(12) Patent Application Publication
(10) Pub. No.: US 2025/0384095 A1
(43) Pub. Date: Dec. 18, 2025

(54) ELECTRONIC DEVICE PROVIDING PERSONALIZED CONTENTS, OPERATION METHOD THEREOF AND RECORDING MEDIUM HAVING OPERATION METHOD RECORDED THEREON

(71) Applicant: Samsung Electronics Co., Ltd., Suwon-si (KR)

(72) Inventors: Miyeoung CHUNG, Suwon-si (KR); Jaeyung YEO, Suwon-si (KR); Huncheol OH, Suwon-si (KR); Seonmin AHN, Suwon-si (KR); Subin LEE, Suwon-si (KR)

(21) Appl. No.: 19/029,090

(22) Filed: Jan. 17, 2025

Related U.S. Application Data
(63) Continuation of application No. PCT/KR2024/020198, filed on Dec. 10, 2024.

(30) Foreign Application Priority Data
Jan. 16, 2024 (KR) 10-2024-0006835
Mar. 29, 2024 (KR) 10-2024-0043037

(51) Int. Cl. G06F 16/9535

(52) U.S. Cl. CPC G06F 16/9535

(57) ABSTRACT

According to an example embodiment, an electronic device may include: at least one processor, comprising processing circuitry; and a memory configured to store instructions, wherein at least one processor, individually and/or collectively, is configured to execute the instructions. The electronic device may identify a first object corresponding to a primary object and a second object corresponding to an additional object among a plurality of objects included in a first content. The electronic device may obtain personalized information related to a user from a second content. The electronic device may obtain at least one input prompt based on the first object, the second object, and the personalized information. The electronic device may provide, through a user interface, a third content which is output from a first artificial intelligence (AI) model by providing the at least one input prompt to the first AI model. The third content may include a third object resulting from changing of at least a part of the second object, and the first object.

### CROSS-REFERENCE TO RELATED APPLICATIONS

This application is a continuation of International Application No. PCT/KR2024/020198 designating the United States, filed on Dec. 10, 2024, in the Korean Intellectual Property Receiving Office and claiming priority to Korean Patent Application Nos. 10-2024-0006835, filed on Jan. 16, 2024, and 10-2024-0043037, filed on Mar. 29, 2024, in the Korean Intellectual Property Office, the disclosures of each of which are incorporated by reference herein in their entireties.

### BACKGROUND

### Field

The disclosure relates to an electronic device which provides personalized contents, an operation method thereof, and a recording medium having the operation method recorded thereon.

### Description of Related Art

A variety of digital information (for example, a still image, a video, an audio, etc.) may be provided through an electronic device. Digital information may be provided from a server or another electronic device through a communication interface, or may be provided from a storage device functionally connected to the electronic device.

For example, a variety of digital information may be generated using an artificial intelligence (AI) system. For example, the digital information generation field using generative AI is developing primarily based on natural language processing and machine learning technologies. As AI systems are more used, their recognition rate increases and they understand user preference more accurately, and accordingly, conventional rule-based smart systems are gradually being replaced with deep learning-based AI systems. AI technology includes machine learning (deep learning) and feature technologies utilizing machine learning.

The above information is presented as related art simply to assist with understanding of the disclosure. No assertion or determination is made as to whether any of the above contents might be applicable as prior art related to the disclosure.

### SUMMARY

According to an example embodiment, an electronic device may include: at least one processor, comprising processing circuitry; and a memory configured to store instructions, wherein at least one processor, individually and/or collectively, is configured to execute the instructions. The electronic device may identify a first object corresponding to a primary object and a second object corresponding to an additional object among a plurality of objects included in a first content. The electronic device may obtain personalized information related to a user from a second content. The electronic device may obtain at least one input prompt based on the first object, the second object, and the personalized information. The electronic device may provide, through a user interface, a third content which is output from a first artificial intelligence (AI) model by providing the at least one input prompt to the first AI model. The third content may include a third object resulting from changing of at least a part of the second object, and the first object.

According to an example embodiment, a method performed by an electronic device, may comprise identifying a first object corresponding to a primary object and a second object corresponding to an additional object among a plurality of objects included in a first content. The method performed by the electronic device may comprise obtaining personalized information related to a user. The method performed by the electronic device may comprise providing a second content created based on the first object, the second object, and the personalized information through a user interface. The second content may include a third object which results from changing of at least a part of the second object, and the first object.

According to an example embodiment, in a non-transitory computer-readable recording medium having instructions recorded thereon which, when executed by at least one processor, comprising processing circuitry, of an electronic device, individually and/or collectively, cause the electronic device to perform at least one operation. The operations performed by the processor may comprise identifying a first object and a second object designated as being changeable through the electronic device among a plurality of objects included in a first content. The operations performed by the processor may comprise obtaining personalized information related to a user from a second content. The operations performed by the processor may comprise providing a third content created based on the first object, the second object, and the personalized information through a user interface. The third content may include a third object resulting from changing at least a part of the second object based on the personalized information, and the first object.

### BRIEF DESCRIPTION OF THE DRAWINGS

Regarding the explanation of the drawings, the same or similar reference numerals may be used for the same or similar components. Further, the above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of an electronic device according to various embodiments;

FIG. 3 is a flowchart illustrating an example method of operating an electronic device according to various embodiments;

FIG. 4 is a block diagram illustrating an example method of operating an electronic device according to various embodiments;

FIG. 5 is a diagram illustrating example exchanged between a first electronic device and a second electronic device according to various embodiments;

FIG. 6 is a diagram illustrating an electronic device classifying objects from a content according to various embodiments;

FIG. 7 is a diagram illustrating an electronic device obtaining personalized information from a content according to various embodiments;

FIG. 8 is a diagram illustrating an electronic device obtaining an input prompt according to various embodiments;

FIG. 9 is a diagram illustrating an electronic device obtaining a content using a generative AI model according to various embodiments;

FIG. 10 is a diagram illustrating an electronic device obtaining a content using a generative AI model according to various embodiments;

FIG. 11 is a diagram illustrating an electronic device obtaining a content using a generative AI model according to various embodiments;

FIG. 12 is a diagram illustrating an electronic device obtaining a content using a generative AI model according to various embodiments;

FIG. 13 is a diagram illustrating an electronic device obtaining a content using a generative AI model according to various embodiments;

FIG. 14 is a diagram illustrating an electronic device obtaining a content using a generative AI model according to various embodiments; and

FIG. 15 is a diagram illustrating an example configuration of a system including a generative AI model according to various embodiments.

### DETAILED DESCRIPTION

Thanks to the development of electronic devices and network technology, contents fed to a user in a web page that the user visits through an electronic device, a social network service (SNS) that the user uses, an application that the user uses may be classified by user according to the time during which contents are viewed, frequency, exposure, types of contents. However, contents are not personalized to users. If contents are personalized to users and are viewed, there is an effect that users pay more attention to the contents.

Hereinafter, various example embodiments of the disclosure will be described in greater detail with reference to the accompanying drawings. However, the disclosure may be implemented in different forms and is not limited to the various embodiments set forth herein. In addition, in the drawings, parts having nothing to do with the descriptions may be omitted for the clear description of the disclosure, and throughout the disclosure, the same or like reference numerals are used for the same or like elements.

The terms used in the disclosure are described as general terms currently used considering the functions mentioned in the disclosure, but may refer to various other terms according to the intent of those skilled in the art, precedent, the emergence of new technologies. Accordingly, the terms used in the disclosure should not be interpreted solely based on their names and should be interpreted based on the meaning of the terms and the whole context of the disclosure.

In addition, such terms as “1st” and “2nd,” or “first” and “second” may be used to explain various components, but the components should not be limited by such terms. These terms may be used for the purpose of distinguishing one component from other components.

Throughout the disclosure, it is to be understood that if an element is referred to as “connected with/to” another element, the element may be “directly connected” with another element or may be “electrically connected” with another element via an intervening element therebetween. It will be further understood that when a certain portion is referred to as “including” a certain element, the certain portion does not exclude other components and may further include other components unless the context clearly indicates otherwise.

The phrase “in an embodiment” used in the disclosure does not necessarily indicate the same embodiment.

An embodiment of the disclosure may be represented by functional block configurations and various processing steps. Some or all of the functional blocks may be implemented by various numbers of hardware and/or software configurations that perform specific functions. For example, the functional blocks of the disclosure may be implemented by one or more microprocessors or may be implemented by circuit configurations for predetermined functions. In addition, for example, the functional blocks of the disclosure may be implemented by various programming or scripting languages. The functional blocks may be implemented by an algorithm that is executed in one or more processors. The disclosure may employ related-art technologies for electronic configuration, signal processing, and/or data processing. Such terms “mechanism”, “element”, “means”, and “configuration” may be broadly used and are not limited to mechanical and physical configurations.

In addition, connecting lines or connecting members among components shown in the drawings are only examples of functional connection and/or physical or circuitry connections. In an actual device, connections among components may be represented by a variety of alternative or additional functional connection, physical connection, or circuit connections.

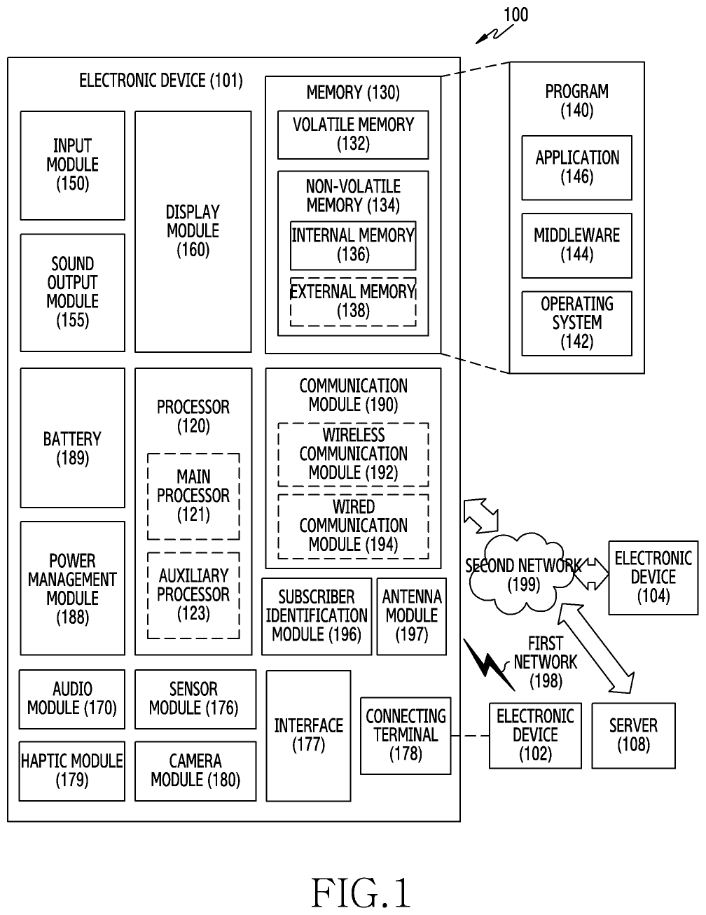

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

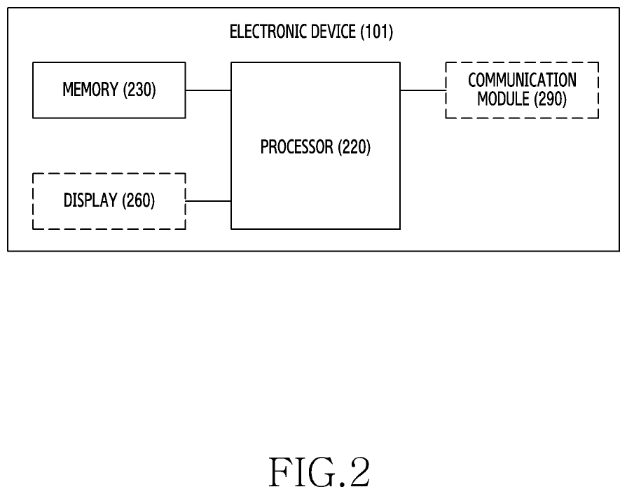

FIG. 2 is a block diagram illustrating an example configuration of an electronic device according to various embodiments. The electronic device 101 according to an embodiment of FIG. 2 may provide a personalized content to a user.

Referring to FIG. 2, the electronic device 101 according to an embodiment may include a processor (e.g., including processing circuitry) 220 and a memory 230. Components of the electronic device 101 illustrated in FIG. 2 are for the purposes of illustration and may include more components than those illustrated in FIG. 2 or may include other components for replacing at least some of the components. For example, the electronic device 101 may include at least one of a display 260 and a communication module (e.g., including communication circuitry) 290. For example, the memory 230 is not limited to a storage medium included in the electronic device 101, and may include a cloud repository external to the electronic device 101. The electronic device 101, the processor 220, the memory 230, the display 260, and the communication module 290 of FIG. 2 may correspond to the electronic device 101, the processor 120, the memory 130, the display module 160, and the communication module 190 described above with reference to FIG. 1, respectively.

According to an embodiment, the memory 230 may store instructions that are executed by the processor 220. The processor 220 may perform computation or may control the components of the electronic device 101 by executing instructions stored in the memory 230. The memory 230 may store at least one module and/or AI model which is implemented as software.

According to an embodiment, the display 260 may display at least one content. The content may include digital information which is provided through a wired or wireless communication network. For example, the content may include, but not be limited to, a video content (for example, a TV program video, a video on demand (VOD), user-created contents (UCC), a music video, a YouTube video), a still image content (for example, a photo, a picture), a text content (for example, an electronic book (poetry, novel), a letter, a work file), a music content (for example, music, performance, radio broadcasting), a web page, and a message.

According to an embodiment, the communication module 290 may include various communication circuitry and exchange data with at least one external electronic device. For example, the communication module 290 may exchange contents with the external electronic device. For example, the communication module 290 may exchange information related to objects included in a content with the external electronic device. For example, the communication module 290 may exchange an input prompt to be provided to a generative AI model with the external electronic device.

According to an embodiment, the processor 220 may control one or more components of the electronic device. The processor 220 may control a component of the electronic device to perform a predetermined function corresponding to instructions by executing the instructions.

In the disclosure, operations of the electronic device 101 may be understood as being performed by the at least one processor 220 executing instructions. For example, the processor 220 of the electronic device 101 may correspond to a plurality of processors which divide a plurality of operations between the processors and perform the operations collectively. According to an embodiment, the processor 220 may include at least one of an application processor (AP), a central processing unit (CPU), an image signal processor (ISP), a graphical processing unit (GPU), or a neural processing unit (NPU). For example, and without limitation, the processor 220 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the processor 220 may identify a first object which is classified as a primary object and a second object which is classified as an additional object from a plurality of objects in a first content. The primary object may include an object for delivering a key message or a purpose of the first content. The additional object may include an object which is disposed in the first content to highlight the primary object. For example, the processor 220 may identify the first object and the second object which are classified by a second AI model from the first content, by providing the first content to the second AI model which is trained to identify objects included in a content. For example, the processor 220 may recognize a first identifier from the first content, and may identify an object that is set as the first object from the first content, based on the first identifier. For example, the processor 220 may recognize a second identifier from the first content, and may identify an object that is set as the second object from the first content, based on the second identifier.

According to an embodiment, the primary object may include an object or a part (for example, an area of an image, a section of an audio, an element of a user interface) in which change is restricted. For example, the additional object may include an object or a part (for example, an area of an image, a section of an audio, an element of a user interface) that is changeable using information related to a user in the electronic device 101. The primary object may include a product appearance, a product name, a company name, a price, a date or an advertising copy which are included in the first content. The additional object may correspond to other objects than the primary object. The additional object may correspond to an object that satisfies a specific condition (for example, a condition in which a type of an object is a portrait, animal or background, a condition in which a size of an area occupied by an object in an image is greater than or equal to a predetermined value) among the objects other than the primary object. For example, the primary object and/or additional object may be designated by a creator or a provider of the first content. For example, the primary object and/or additional object may be identified by an AI model. For example, in embodiments of the disclosure, a part of sub-attributes of an object may be classified as a primary attribute, and the other part may be classified as an additional attribute.

According to an embodiment, the processor 220 may obtain personalized information which is related to a user from a second content used by the user. For example, the processor 220 may obtain personalized information from a content (for example, a video, a photo, music, an application) which is being replayed in the electronic device 101. For example, the processor 220 may obtain personalized information from a content to be replayed in the electronic device 101 (for example, a video, a photo, music, an application). For example, the processor 220 may obtain personalized information from context information (for example, location information, information on a screen which is displayed by the electronic device, environmental information of the electronic device, state information of the electronic device, state information of the user, or schedule information of the user), which is obtained by the user using the electronic device 101. For example, the processor 220 may obtain personalized information output from a third AI model, by providing at least one content to the third AI model that is trained to obtain a weight value on each of predetermined types from a content. For example, the electronic device 101 may obtain personalized information output from the third AI model by providing an image (for example, a fourth content) which is being currently displayed by the electronic device 101 to the third AI model. For example, the electronic device 101 may obtain personalized information output from the third AI model by providing an image (for example, a fifth content) to be displayed after a third content is displayed to the third AI model.

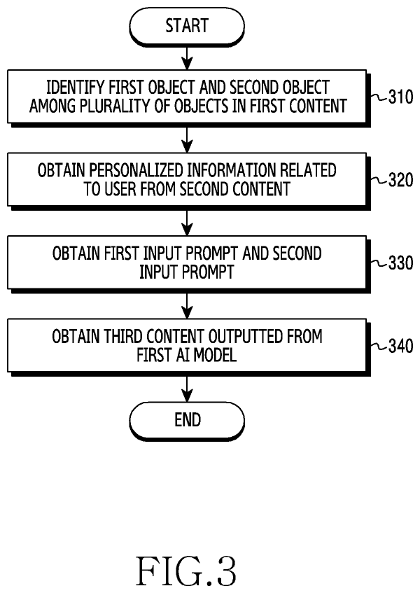

According to an embodiment, the processor 220 may obtain a first input prompt including at least a part of features related to the primary object identified from the content. For example, the processor 220 may generate the first input prompt including at least a part of features related to the first object identified from an image (for example, the first content) in order to obtain a third content which is output by performing operation 340 of FIG. 3 by the electronic device 101.

According to an embodiment, the processor 220 may obtain a second input prompt, based on the additional object identified from the content and the personalized information. For example, the processor 220 may generate the second input prompt including at least a part of features related to the additional object. For example, the processor may obtain the second input prompt including at least a part of features related to the second object identified from the image (for example, the first content) in order to obtain the third content which is output by performing operation 340 of FIG. 3 by the electronic device. For example, the electronic device may obtain the second input prompt including at least a part of the personalized information output from the AI model, by providing the image (for example, the fourth content) currently displayed by the electronic device to an AI model that is trained to obtain a weight value on each of predetermined types from a content. For example, the electronic device may obtain the second input prompt including at least a part of the personalized information output from the AI model, by providing the image (for example, the fifth content) to be displayed after the third content is displayed to an AI model that is trained to obtain a weight value on each of predetermined types from a content.

For example, the processor 220 may obtain the second input prompt including at least a part of the information on the second object and at least a part of the personalized information. For example, the personalized information may include information relevant to the user based on user's interest, preference, need, situation. For example, the personalized information may include information related to at least a part of user's face and body. For example, the personalized information may include context information (for example, location information, information on a screen displayed by the electronic device, environmental information of the electronic device, state information of the electronic device, state information of the user, or schedule information of the user) which is obtained by the user using the electronic device. For example, the processor 220 may obtain the second input prompt including at least a part of features obtained from an image related to the user.

According to an embodiment, the processor 220 may obtain the third content output from a first AI model, by providing at least a part of the first input prompt and at least a part of the second input prompt to the first AI model which is trained to generate personalized contents. For example, the third content may include a third object resulting from substitution for the second object or changing of at least a part of the second object, and the first object.

According to an embodiment, the first and second input prompts may be configured as one input prompt.

According to an embodiment, the processor 220 may identify the first object and the second object which are classified by the second AI model from the first content, by providing the first content to the second AI model which is trained to identify objects included in a content.

According to an embodiment, at least a part of the AI models according to the disclosure may be provided by the electronic device 101 or another electronic device (for example, a server). For example, in the above-described embodiment, the first AI model may be located in a server, and the second and third AI models may be located in the electronic device 101.

According to an embodiment, at least some models of the first, second, and third AI models may correspond to modules which are included in one AI system to provide different functions.

According to an embodiment, at least a part of operations using AI according to the disclosure may be performed by the processor 220 of the electronic device. For example, the first content (for example, an original content) may be changed to the third content (for example, a content resulting from modification of the original content) through a processor specialized for processing of an AI model or the auxiliary processor 123.

Functions related to the AI according to the disclosure may be operated through the processor 220 and the memory 230. The processor 220 may be comprised of one or a plurality of processors. In this case, the one or plurality of processors may be a general purpose processor such as a central processing unit (CPU), an application processor (AP), a digital signal processor (DSP), a graphic-dedicated processor such as a graphical processing unit (GPU), a vision processing unit (VPU), or an AI-dedicated processor such as a neural processing unit (NPU). The one or plurality of processors may control to process input data according to a pre-defined operating rule stored in the memory 230, or an AI model. Alternatively, when the one or plurality of processors are AI-dedicated processors, the AI-dedicated processors may be designed as hardware structures specialized for processing of a specific AI model. The processor may perform a pre-processing operation for transforming data to be applied to an AI model into a format suitable for applying to the AI model.

According to an embodiment, the AI model may be comprised of a plurality of neural network layers. Each of the plurality of neural network layers may have a plurality of weight values, and may perform neural network computation through a result of computation of a previous layer and computation between the plurality of weight values. The plurality of weight values of the plurality of neural network layers may be optimized by a result of learning by the AI model. For example, the plurality of weight values may be refined to reduce or minimize a loss value or a cost value which is obtained in the AI model during the learning process.

The AI model according to the disclosure may be made through learning. The AI model being made through learning may refer, for example, to a pre-defined operating rule or an AI model set to perform a desired feature (or purpose) being made by a basic AI model learning from a plurality of pieces of training data by a learning algorithm. The disclosed AI model may be an AI model that is generated by learning from a plurality of pieces of text data and image data, which are input as training data, according to a predetermined criterion. The AI model may generate resulting data by performing a learned function in response to input data, and may output the resulting data. Such learning may be performed in a device which performs AI according to the disclosure, and may be performed through a separate server (for example, the server 108 of FIG. 1) and/or system. The server (for example, the server 108 of FIG. 1) may exchange data with the electronic device 101. For example, the server (for example, the server 108 of FIG. 1) may apply data received from the electronic device 101 to the AI model, and may transmit data output from the AI model to the electronic device 101. In another example, the server (for example, the server 108 of FIG. 1) may transmit data that is used for refining an AI model established in the electronic device 101 to the electronic device 101. In addition, the disclosed AI model may include a plurality of AI models which are trained to perform at least one function. A plurality of AI models performing the same function may be provided, and one AI model may perform at least one function of the disclosed embodiments. The AI model according to the disclosure may be established in at least one of the electronic device 101 and the server (for example, the server 108 of FIG. 1).

According to an embodiment, the electronic device 101 may receive information on the trained AI model from the server (for example, the server 108 of FIG. 1). For example, the server (for example, the server 108 of FIG. 1) may train the AI model established in the server, and may transmit data on the AI model which is refined by training to the electronic device 101. In this case, the electronic device 101 may receive information on weight values which are refined among the weight values of the AI model, and may refine the AI model established in the electronic device 101 using the received information.

The AI model according to the disclosure may include a personalized AI model. The personalized AI model may include a model that is personalized from a general purpose AI model using personalized information. Personalization may include refining, by the general purpose AI model, data related to at least some neural network layers of the general purpose AI model, by training the general purpose AI model with user's personal data to enhance user accuracy.

The AI model used in the disclosed embodiments may be implemented by various embodiments according to a manufacturer of the electronic device or the user of the electronic device, and is not limited to the above-described examples.

FIG. 3 is a flowchart illustrating an example method of operating an electronic device according to various embodiments. Operations of the electronic device (for example, the electronic device 101 of FIGS. 1 and 2) shown in FIG. 3 may be performed by a processor (for example, the processor 220 of FIG. 2) performing computation, or by controlling components of the electronic device (for example, the electronic device 101 of FIGS. 1 and 2). In various embodiments described below, operations may be performed in sequence but may not necessarily be performed in sequence. For example, the order of the operations may be changed and at least two operations may be performed in parallel.

According to an embodiment, in operation 310, the electronic device may identify a first object and a second object among a plurality of objects in a first content. For example, the electronic device may identify at least one object included in at least one content. The electronic device may classify the identified objects as a primary object or an additional object. The primary object may include an object for delivering a key message or a purpose of the first content. The additional object may include an object that is disposed in the first content to highlight the primary object. The first content may include digital information to be provided to a user. For example, the first content may include at least one of a still image, a video, a text, music, a web page, or a message.

According to an embodiment, the electronic device may identify the first object classified as the primary object and the second object classified as the additional object among the plurality of contents in the first content. For example, the electronic device may identify the first object and the second object which are classified by a second AI model from the first content, by providing the first content to the second AI model which is trained to identify objects included in a content. For example, the electronic device may identify a first identifier from the first content, and may identify an object that is set as the first object from the first content, based on the first identifier. For example, the electronic device may identify a second identifier from the first content, and may identify an object that is set as the second object from the first content, based on the second identifier.

According to an embodiment, in operation 320, the electronic device may obtain personalized information related to the user from a second content. For example, the second content may include a content related to the user. For example, the second content may include user data. For example, the electronic device may obtain personalized information from a content (for example, a video, a photo, music, an application) which is being replayed in the electronic device. For example, the electronic device may obtain personalized information from a content (for example, a video, a photo, music, an application) to be replayed in the electronic device. For example, the second content may include personal identification information of the user. For example, the second content may include location information of the user. For example, the second content may include context information. The context information may include information indicating a situation of the electronic device. For example, the context information may include at least one of information on a screen which is being displayed by the electronic device, environmental information of the electronic device, state information of the electronic device, state information of the user, or schedule information of the user.

According to an embodiment, the electronic device may obtain personalized information output from a third AI model, by providing the second content to the third AI model that is trained to obtain weight values on predetermined types from a content. For example, the electronic device may obtain personalized information output from the third AI model by applying user data to the third AI model. For example, the electronic device may obtain personalized information output from the third AI model, by providing an image (for example, a fourth content) which is being currently displayed by the electronic device to the third AI model. For example, the electronic device may obtain personalized information output from the third AI model, by providing an image (for example, a fifth content) to be displayed after a third content is displayed to the third AI model. For example, the electronic device may obtain personalized information output from the third AI model, by providing context information (for example, location information, information on a screen which is being displayed by the electronic device, environmental information of the electronic device, state information of the electronic device, state information of the user, or schedule information of the user) to the third AI model.

According to an embodiment, in operation 330, the electronic device may obtain a first input prompt and a second input prompt. The input prompt may include information on a content to be generated by a generative AI model. For example, the electronic device may obtain an input prompt including at least a part of features of at least one object identified from at least one content.

According to an embodiment, the electronic device may obtain the first input prompt including at least a part of features related to the primary object identified from the content. For example, the electronic device may obtain the first input prompt including at least a part of features related to the first object identified from the image (for example, the first content) input to the electronic device in order to obtain a third content which is output by performing operation 340 by the electronic device.

According to an embodiment, the electronic device may obtain the second input prompt including at least a part of features related to the additional object identified from the content. For example, the electronic device may obtain the second input prompt including at least a part of features related to the second object identified from the image (for example, the first content) input to the electronic device in order to obtain the third content which is output by performing operation 340 by the electronic device.

According to an embodiment, the electronic device may obtain the second input prompt including at least a part of the features related to the additional object and at least a part of the personalized information. The personalized information may include information relevant to the user based on user's interest, preference, need, situation. For example, the personalized information may include information related to at least a part of user's face and body. For example, the personalized information may include information obtained from context information (for example, location information, information on a screen displayed by the electronic device, environmental information of the electronic device, state information of the electronic device, state information of the user, or schedule information of the user). For example, the electronic device may obtain the second input prompt including at least a part of features obtained from an image related to the user. For example, the electronic device may obtain the second input prompt including at least a part of features obtained from a content (for example, a video, a photo, music, an application) which is being replayed in the electronic device. For example, the electronic device may obtain the second input prompt including at least a part of features obtained from a content (for example, a video, a photo, music, an application) to be replayed in the electronic device. For example, the electronic device may obtain the second input prompt including at least a part of features obtained from context information (for example, location information, information on a screen which is being displayed by the electronic device, environmental information of the electronic device, state information of the electronic device, state information of the user, or schedule information of the user).

According to an embodiment, in operation 340, the electronic device may obtain a third content output from a first AI model. The first AI model may include a generative AI model. The generative AI model may include an AI model that creates a predetermined content based on a prompt input. For example, the generative AI model may include an AI model that creates or modifies a designated type of content upon receiving a natural language prompt input of a user. For example, the generative AI model may include, but not be limited to, a conversation AI model, an image generation AI model, an AI model for composing music, an AI model for writing, and/or an AI model for coding.

According to an embodiment, the electronic device may obtain the third content output from the first AI model, by providing at least a part of the first input prompt and at least a part of the second input prompt to the first AI model that is trained to create a personalized content. For example, the electronic device may obtain the third content including a third object resulting from substitution for the second object, and the first object.

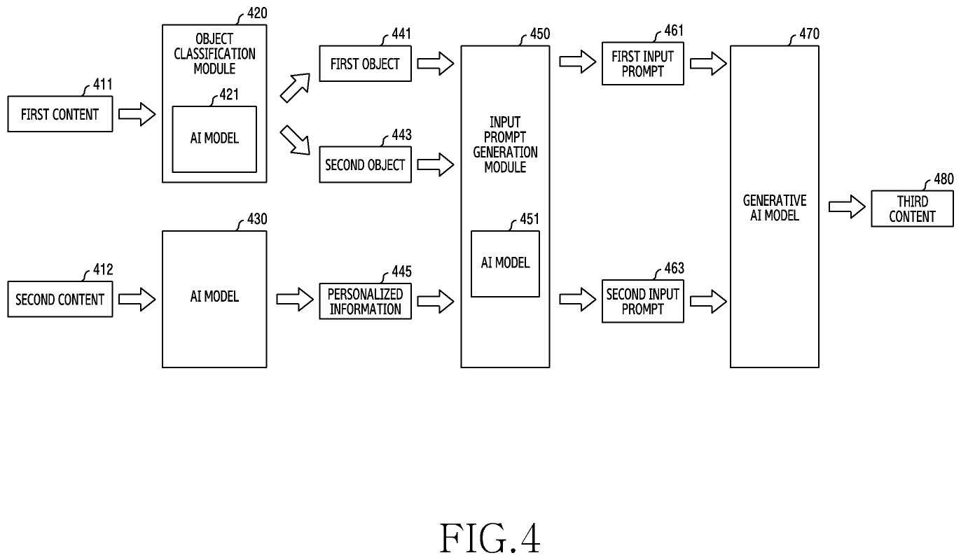

FIG. 4 is a block diagram illustrating an example method of operating an electronic device according to various embodiments. FIG. 4 may include the operations performed by the electronic device 101, which has been described above with reference to FIG. 1 or 2. Operations of the electronic device illustrated in FIG. 4 may be performed by a processor (for example, the processor 220 of FIG. 2) performing computation or controlling components of the electronic device. A “module” used in FIG. 4 may be implemented by hardware or software, or any combination thereof, to perform a predetermined function. An AI model used in FIG. 4 may include an AI model that is implemented by hardware or software to perform a predetermined function.

According to an embodiment, a first content according to embodiments of the disclosure may include an original advertising content (for example, an image). The electronic device 101 may obtain an original advertising content created by a content provider as the first content. The electronic device 101 may identify a multimedia content (for example, a movie, a drama, broadcasting, music, audio, an image captured in the electronic device) provided to a user as a second content. According to an embodiment, the electronic device 101 may pause the multimedia content in the middle of providing the multimedia content to the user and may provide the advertising content. For example, the electronic device 101 may modify the original advertising content using an object (for example, image information, multimedia data) included in a portion that is replayed before the time that the advertising content should be provided, in the multimedia content provided to the user, and may provide the modified advertising content as a third content. For example, an object that is included in a replay section of the multimedia content already provided to the user may be added to the original advertising content or may be substituted for a part of the original advertising content. For example, the electronic device 101 may modify the original advertising content using an object (for example, image information, multimedia data) included in a part to be replayed after the time the advertising content should be provided, in the multimedia content provided to the user, and may provide the modified advertising content as the third content. For example, an object that is included in a replay section of the multimedia content to be provided to the user after the advertising content is provided may be added to the original advertising content, or may be substituted for a part of the original advertising content.

According to an embodiment, the electronic device (for example, the electronic device 101 of FIG. 1) may provide the first content 411 to an object classification module 420. The object classification module 420 may include hardware and/or software which is implemented to identify objects included in a content and to classify types of the identified objects. For example, the object classification module 420 may include an AI module 421 that is trained to identify objects included in a content and to classify types. For example, the object classification module 420 may be a hardware and/or software module that is implemented to recognize an identifier included in a content and to identify a first object and a second object which are set based on the identifier. For example, the electronic device (for example, the electronic device 101 of FIG. 1) may provide the first content to the object classification module 420 implemented in the electronic device (for example, the electronic device 101 of FIG. 1) as input data. For example, the electronic device (for example, the electronic device 101 of FIG. 1) may provide the first content 411 to the object classification module 420 by transmitting the first content 411 to an external electronic device (for example, the electronic device 102 of FIG. 1) in which the object classification module 420 is implemented.

According to an embodiment, a plurality of objects included in the first content 411 may be identified by analyzing the first content 411 input to the object classification module 420. Data output from the object classification module 420 may include information and/or features related to an object identified from the first content 411. For example, data output from the object classification module 420 may include information related to an appearance (for example, a size, a shape, a color) of each of the objects. For example, data output from the object classification module 420 may include information on a location of an object in the first content. For example, data output from the object classification module 420 may include information on a content of a text included in an object including the text. The above-described example is simply for explaining examples of various embodiments, and the disclosure is not limited thereto.

According to an embodiment, data output from the object classification module 420 may include information on the type of the object identified from the first content 411. The plurality of objects included in the first content may be classified by type through the object classification module 420. For example, each of the plurality of objects may be classified as a first object 441 or a second object 443 through the object classification module 420. The first object 441 may include a primary object among the plurality of objects of the first content 411. The primary object may include an object for delivering a key message or a purpose of the first content. The second object 443 may include an additional object among the plurality of objects of the first content 411. The additional object may include an object disposed in the first content to highlight the primary object. For example, the plurality of objects included in the first content 411 may be classified as the first object 441 or the second object 443 by the AI model 421 which is trained to identify objects included in a content and to classify types. For example, the plurality of objects included in the first content 411 may be classified as the first object 441 or the second object 443 by the object classification module 420 which is implemented to recognize an identifier included in a content and to identify a first object and a second object which are set, based on the identifier.

According to an embodiment, the electronic device (for example, the electronic device 101 of FIG. 1) may provide the second content 412 to an AI model 430. The AI model 430 may include an AI model that is trained to obtain weight values on predetermined types from a content. For example, the electronic device (for example, the electronic device 101 of FIG. 1) may provide the second content to the AI model 430 implemented in the electronic device (for example, the electronic device 101 of FIG. 1) as input data. For example, the electronic device (for example, the electronic device 101 of FIG. 1) may provide the second content 412 to the AI model 430 by transmitting the second content 412 to an external electronic device (for example, the electronic device 102 of FIG. 1) in which the AI model 430 is implemented.

According to an embodiment, the second content 412 may include content related to the user. For example, the second content 412 may include personal identification information such as user's name, sex, birth date, address, phone number, email address, and resident registration number. For example, the second content 412 may include personal body information such as a face photo, voice information. For example, the second content 412 may include user's personal data. The user's personal data may include private data of the user which is obtained by a user terminal. For example, the user's personal data may may include at least one of images which are captured by the user using the user terminal, location information of the user which is obtained using a location sensor of the user terminal, voice data of the user which is obtained through a microphone of the user terminal, a pattern for using the user terminal of the user, addresses of web pages that the user visits using the electronic device, information on applications which are executed by the user in the electronic device, information on user's history of searching, activities (for example, posts, comments, messages) of the user in a social network service (SNS), or information on user's history of purchasing products. For example, the second content 412 may include image data which is stored in the electronic device used by the user. For example, the second content 412 may include, for example, a content (for example, a video, a photo, music, an application) which is being replayed in the electronic device. For example, the second content 412 may include a content (for example, a video, a photo, music, an application) to be replayed in the electronic device.

According to an embodiment, the second content 412 may include context information. The context information may include, but not be limited to, at least one of environmental information of the electronic device (for example, the electronic device 101 of FIG. 1), state information of the electronic device (for example, the electronic device 101 of FIG. 1), state information of the user, or scheduling information of the user, as information indicating a situation of the electronic device (for example, the electronic device 101 of FIG. 101).

For example, the environmental information of the electronic device (for example, the electronic device 101 of FIG. 1) may include environmental information within a predetermined range from the electronic device (for example, the electronic device 101 of FIG. 1). For example, the environmental information of the electronic device (for example, the electronic device 101 of FIG. 1) may include, but not be limited to, weather information, place information, temperature information, humidity information, illuminance information, noise information, sound information.

For example, the state information of the electronic device (for example, the electronic device 101 of FIG. 1) may include, but not be limited to, mode information (for example, a sound mode, a vibration mode, a mute mode, a power-saving mode, a blocking mode, a multi-window mode, an auto-rotation mode) of the electronic device (for example, the electronic device 101 of FIG. 1), location information of the electronic device (for example, the electronic device 101 of FIG. 1), time information, activation information of a communication module (for example, WiFi ON/Bluetooth OFF/global positioning system (GPS) ON/near field communication (NFC) ON), network access state information of the electronic device (for example, the electronic device 101 of FIG. 1).

For example, the state information of the user may include, but not be limited to, information on user's walking state, exercising state, driving state, sleeping state, mood state as information on the motion, lifestyle pattern of the user.

According to an embodiment, the second content 412 input to the AI model 430 may be analyzed, such that personalized information related to the user is output from the AI model 430. The personalized information may include information related to the user based on user's interest, preference, need, situation. The personalized information output from the AI model 430 may include at least one of information on user's sex, information on user's age, information on each of images stored in a gallery application of the user, information on user's taste, information on user's favorite color, information on user's interest, information on products that the user is interested in, information on the outfit that the user wears, information on when the user purchased the product the user wears, information on the space where the user lives, or information on the product that the user uses. For example, the personalized information may include at least a part of the second content. The above-described example is simply for explaining examples of various embodiments and the disclosure is not limited thereto.

According to an embodiment, the electronic device may input the first object 441, the second object 443, and the personalized information to an input prompt generation module 450. The input prompt generation module 450 may include hardware and/or software that is implemented to generate a prompt to be input to a generative AI model 470, based on input data. The input prompt generation module 450 may include an AI model 451 that is trained to identify input data and to generate a prompt based on the input data. For example, the electronic device (for example, the electronic device 101 of FIG. 1) may provide, as input data, the first object 441, the second object 443, and the personalized information 445 to the input prompt generation module 450 which is implemented in the electronic device (for example, the electronic device 101 of FIG. 1). For example, the electronic device (for example, the electronic device 101 of FIG. 1) may provide the first object 441, the second object 443, and the personalized information 445 to the input prompt generation module 450 by transmitting the first object 441, the second object 443, and the personalized information 445 to an external electronic device (for example, the electronic device 102 of FIG. 1) in which the input prompt generation module 450 is implemented. For example, the electronic device (for example, the electronic device 101 of FIG. 1) may provide the first object 441, the second object 443, and the personalized information 445 to the input prompt generation module 450 by providing information on features related to each of the first object 441, the second object 443, and the personalized information 445 to an external electronic device (for example, the electronic device 102 of FIG. 1) in which the input prompt generation module 450 is implemented.

According to an embodiment, the electronic device (for example, the electronic device 101 of FIG. 1) may obtain an input prompt output from the input prompt generation module 450. For example, the electronic device (for example, the electronic device 101 of FIG. 1) may obtain a first input prompt 461 output from the input prompt generation module 450. For example, the electronic device (for example, the electronic device 101 of FIG. 1) may obtain a second input prompt 463 output form the input prompt generation module 450.

For example, the first input prompt 461 may include an input prompt output from the input prompt generation module 450 based on the first object 441. For example, the electronic device (for example, the electronic device 101 of FIG. 1) may obtain the first input prompt 461 including at least a part of the features related to the first object 441 and at least a part of feature related to a third object, based on the third object and the first object 441 which are identified as primary objects from a content which is being displayed. For example, the electronic device (for example, the electronic device 101 of FIG. 1) may obtain the first input prompt 461 including at least a part of the features related to the first object 441 and at least a part of feature related to a fifth object, based on the fifth object and the first object 441 which are identified as primary objects from a content to be displayed. The above-described example is simply for explaining examples of various embodiments and the disclosure is not limited thereto.

For example, the second input prompt 463 may include an input prompt output from the input prompt generation module 450, based on the second object 443 and the personalized information 445. For example, the electronic device (for example, the electronic device 101 of FIG. 1) may obtain the second input prompt 463 including at least a part of features obtained from an image related to the user. For example, the electronic device (for example, the electronic device 101 of FIG. 1) may obtain the second input prompt 463 including at least a part of information related to the second object 443 and at least a part of the personalized information. The above-described example is simply for explaining examples of various embodiments and the disclosure is not limited thereto.

According to an embodiment, the electronic device (for example, the electronic device 101 of FIG. 1) may provide the input prompt output from the input prompt generation module 450 to the generative AI model 470. The generative AI model 470 may include an AI model that is trained to create a personalized content. For example, the generative AI model 470 may include an AI model that receives a natural language prompt input, an image prompt input and/or an audio prompt input, and creates or modifies a designated type of content. For example, the generative AI model may include a conversation AI model, an image generation AI model, an AI model for composing music, an AI model for writing, and/or an AI model for coding. The above-described example is simply for explaining examples of various embodiments and the disclosure is not limited thereto.

According to an embodiment, the electronic device (for example, the electronic device 101 of FIG. 1) may provide at least a part of the first input prompt 461 and at least a part of the second input prompt 463, which are output from the input prompt generation module 450, to the generative AI model 470. For example, the first input prompt 461 may be generated based on the first object 441 provided to the input prompt generation module 450. For example, the second input prompt 463 may be generated based on the second object 443 and the personalized information 445 which are provided to the input prompt generation module 450.

According to an embodiment, the electronic device 101 may obtain the third content 480 through the generative AI model 470 by delivering the first content 411 and the personalized information 445 (and/or the second content 412) to the generative AI model 470 along with an input prompt which is comprised of a text including a generation command and generation conditions of the third content 480.

According to an embodiment, the electronic device (for example, the electronic device 101 of FIG. 1) may obtain the third content 480 output from the generative AI model 470. For example, the electronic device (for example, the electronic device 101 of FIG. 1) may obtain the third content 480 including at least one of a text, an image or a sound. The third content 480 may include a video content (for example, a TV program image, a video on demand (VOD), user-created contents (UCC), a music video, a YouTube video), a still image content (for example, a photo, a picture), a text content (for example, an electronic book (poetry, novel), a letter, a work file), a music content (for example, music, performance, radio broadcasting), a web page, and a message. The above-described example is simply for explaining examples of various embodiments, and the disclosure is not limited thereto.

According to an embodiment, the electronic device (for example, the electronic device 101 of FIG. 1) may output the third content 480. For example, the electronic device (for example, the electronic device 101 of FIG. 1) may output the third content 480 through at least one of a display (for example, the display 260 of FIG. 2) or an audio module (for example, the audio module 170 of FIG. 1) of the electronic device (for example, the electronic device 101 of FIG. 1). For example, the electronic device (for example, the electronic device 101 of FIG. 1) may output the third content 480 through an external electronic device by transmitting the third content 480 to the external electronic device. For example, the electronic device (for example, the electronic device 101 of FIG. 1) may transmit the third content 480 to the external electronic device to output the third content 480 through at least a part of the display and the audio module of the external electronic device.

According to an embodiment, the electronic device 101 may update at least a part of the primary object (for example, the first object 441) based on information received from a provider or a creator of the first content, and may provide the updated information through the third content 480. For example, when the primary object (for example, the first object 441) is an image on a product more suited to men and it is determined that the user of the electronic device 101 is a woman based on the second content 412 or the personalized information 445, the electronic device 101 may obtain a product and a product image which are more suited to women, and may provide the same in the third content 480.

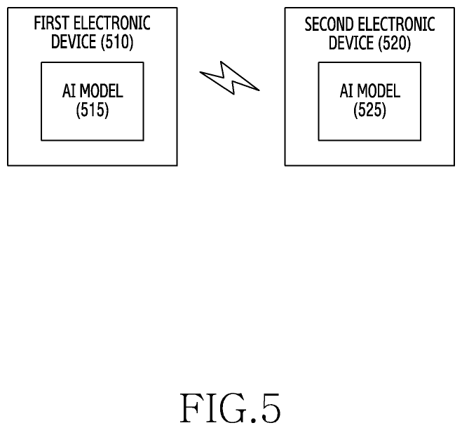

FIG. 5 is a diagram illustrating example exchange of data between a first electronic device and a second electronic device according to various embodiments. Referring to FIG. 5, the first electronic device 510 and the second electronic device 520 may exchange data with each other. The first electronic device 510 and the second electronic device 520 may exchange data to process or compute a variety of data. The first electronic device 510 and the second electronic device 520 may exchange data for controlling. The first electronic device 510 may correspond to the electronic device 101 described above with reference to FIGS. 1 and 2. The second electronic device 520 may correspond to at least one of the electronic device 102, 104 and the server 108 described above with reference to FIGS. 1 and 2.

The first electronic device 510 of FIG. 5 may include a computing device such as a mobile device (for example, a smart phone, a tablet PC) that exchanges data with the second electronic device 520 through a network, a personal computer (PC). The first electronic device 510 of FIG. 5 may include a computing device in which an AI model 515 is established, such as a mobile device (for example, a smart phone, a tablet PC), a PC, a server. For example, the AI model 515 implemented in the first electronic device 510 of FIG. 5 may be implemented by a hardware chip. For example, the AI model 515 implemented in the first electronic device 510 of FIG. 5 may be implemented by software and may be stored in a memory of the first electronic device 510.

The second electronic device 520 of FIG. 5 may include a computing device such as a mobile device (for example, a smart phone, a tablet PC) that exchanges data with the first electronic device 510 through a network, a personal computer (PC). The second electronic device 520 of FIG. 5 may include a computing device in which an AI model 525 is established, such as a mobile device (for example, a smart phone, a tablet PC), a PC, a server. For example, the AI model 525 implemented in the second electronic device 520 of FIG. 5 may be implemented by a hardware chip. For example, the AI model 525 implemented in the second electronic device 520 of FIG. 5 may be implemented by software and may be stored in a memory of the second electronic device 510.

According to an embodiment, the first electronic device 510 may transmit a first content (for example, the first content 411 of FIG. 4) to the second electronic device 520. For example, the first electronic device 510 may transmit the first content to input to an object classification module (for example, the object classification module 420 of FIG. 4) implemented in the second electronic device 520. For example, the object classification module (for example, the object classification module 420 of FIG. 4) may be implemented by a hardware chip mounted in the second electronic device 520. For example, the object classification module (for example, the object classification module 420 of FIG. 4) may be implemented by software and may be stored in the memory of the second electronic device 520. For example, the object classification module (for example, the object classification module 420 of FIG. 4) may be implemented by the AI model 525 that is trained to identify objects included in a content and to classify types. For example, the first electronic device 510 may transmit the simplified first content (for example, a thumbnail) to the second electronic device 520. For example, the first electronic device 510 may transmit the first content which is pre-processed to correspond to the AI model 525 to the second electronic device 520. For example, the first electronic device 510 may transmit features obtained from the first content by the AI model 515 to the second electronic device 520.

According to an embodiment, the second electronic device 520 may transmit data output from the object classification module (for example, the object classification module 420 of FIG. 4) implemented in the second electronic device 520 to the first electronic device 510. For example, data output from the object classification module (for example, the object classification module 420 of FIG. 4) may include information and/or features related to the object identified from the first content (for example, the first content 411 of FIG. 4). For example, the second electronic device 520 may transmit information on an appearance (for example, a size, a shape, a color) of each of the objects output from the object classification module to the first electronic device 510. For example, the second electronic device 520 may transmit information on a location of each of the objects output from the object classification module in the first content to the first electronic device 510. For example, the second electronic device 520 may transmit information on the content of a text output from the object classification module to the first electronic device 510. For example, the second electronic device 520 may transmit information on types of objects (for example, a primary object, an additional object) identified from the first content to the first electronic device 510. The above-described example is simply for explaining examples of various embodiments and the disclosure is not limited thereto.

According to an embodiment, the first electronic device 510 may transmit a second content (for example, the second content 412 of FIG. 4) to the second electronic device 520. For example, the first electronic device 510 may transmit the second content to input to the AI model 525 implemented in the second electronic device 520. For example, the AI model 525 may include an AI model that is trained to obtain a weight value on each of predetermined types from a content. For example, the AI model 525 may be implemented by a hardware chip mounted in the second electronic device 520. For example, the AI model 525 may be implemented by software and may be stored in the memory of the second electronic device 520. For example, the first electronic device 510 may transmit the simplified second content (for example, a thumbnail) to the second electronic device 520. For example, the first electronic device 510 may transmit the second content which is pre-processed to be appropriate for applying to the AI model 525 to the second electronic device 520. For example, the first electronic device 510 may transmit features obtained from the second content by the AI model 515 to the second electronic device 520.

According to an embodiment, the second electronic device 520 may transmit personalized information (for example, the personalized information 445 of FIG. 4) output from the AI model 525 to the first electronic device 510. For example, the second electronic device 520 may transmit, to the first electronic device 510, at least one of information on user's sex, information on user's age, information on each of images stored in a gallery application of the user, information on user's taste, information on user's favorite color, information on user's interest, information on products that the user is interested in, information on the outfit that the user wears, information on when the user purchased the product the user wears, information on the space where the user lives, or information on the product that the user uses. The above-described example is simply for explaining examples of various embodiments and the disclosure is not limited thereto.

According to an embodiment, the first electronic device 510 may transmit data output from the object classification module (for example, the object classification module 420 of FIG. 4) implemented in the first electronic device 510 to the second electronic device 520. For example, the first electronic device 510 may transmit data output from the object classification module to the second electronic device 520 in order to input information on a first object (for example, the first object 441 of FIG. 4) and a second object (for example, the second object 443 of FIG. 4) to an input prompt generation module (for example, the input prompt generation module 450 of FIG. 4) implemented in the second electronic device 520. For example, data output from the object classification module may include information and/or features related to an object identified from the first content. For example, the first electronic device 510 may transmit information on the first object and the second object to the second electronic device 520. For example, the first electronic device 510 may transmit information on an appearance (for example, a size, a shape, a color) of each of the first object and the second object to the second electronic device 520. For example, the first electronic device 510 may transmit information on locations of the first object and the second object in the first content to the second electronic device 520. For example, the first electronic device 510 may transmit information on the content of a text included in each of the first object and the second object to the second electronic device 520. The above-described example is simply for explaining examples of various embodiments and the disclosure is not limited thereto.

According to an embodiment, the first electronic device 510 may transmit the personalized information (for example, the personalized information 445 of FIG. 4) to the second electronic device 520. For example, the first electronic device 510 may transmit the personalized information to the second electronic device 520 in order to input the personalized information (for example, the personalized information 445 of FIG. 4) to the input prompt generation module (for example, the input prompt generation module 450 of FIG. 4) implemented in the second electronic device 520. For example, the first electronic device 510 may transmit the personalized information output from the AI model 515 to the second electronic device 520. For example, the first electronic device 510 may transmit, to the second electronic device 520, at least one of information on user's sex, information on user's age, information on each of images stored in a gallery application of the user, information on user's taste, information on user's favorite color, information on user's interest, information on products that the user is interested in, information on the outfit that the user wears, information on when the user purchased the product the user wears, information on the space where the user lives, or information on the product that the user uses. The above-described example is simply for explaining examples of various embodiments and the disclosure is not limited thereto.

According to an embodiment, the second electronic device 520 may transmit data output from the input prompt generation module (for example, the input prompt generation module 450 of FIG. 4) implemented in the second electronic device 520 to the first electronic device 510. For example, the second electronic device 520 may transmit at least a part of a first input prompt (for example, the first input prompt 461 of FIG. 4) and at least a part of a second input prompt (for example, the second input prompt 463 of FIG. 4) to the first electronic device 510.

For example, the input prompt generation module (for example, the input prompt generation module 450 of FIG. 4) may be implemented by a hardware chip mounted in the second electronic device 520. For example, the input prompt generation module (for example, the input prompt generation module 450 of FIG. 4) may be implemented by software and may be stored in the memory of the second electronic device 520. For example, the input prompt generation module (for example, the input prompt generation module 461 of FIG. 4) implemented in the second electronic device 520 may be implemented by the AI model 525 which is trained to generate a prompt based on input data. For example, the AI model 525 which implements the input prompt generation module may include a generative AI model.

For example, data output from the input prompt generation module (for example, the input prompt generation module 450 of FIG. 4) may include the first input prompt (for example, the first input prompt 461 of FIG. 4) and the second input prompt (for example, the second input prompt 463 of FIG. 4). For example, the first input prompt may include an input prompt which is generated based on the first object. For example, the second input prompt may include an input prompt which is generated based on the second object and the personalized information. For example, the second input prompt may include at least a part of information on the second object and at least a part of the personalized information. For example, the second input prompt may include at least a part of features obtained from an image related to the user.

According to an embodiment, the first electronic device 510 may transmit at least a part of the first input prompt (for example, the first input prompt 461 of FIG. 4) and at least a part of the second input prompt (for example, the second input prompt 463 of FIG. 4) to the second electronic device 520. For example, the first electronic device 510 may transmit, to the second electronic device 520, the first input prompt (for example, the first input prompt 461 of FIG. 4) and the second input prompt (for example, the second input prompt 463 of FIG. 4) output from the input prompt generation module implemented in the first electronic device 510. For example, the first electronic device 510 may transmit the first input prompt (for example, the first input prompt 461 of FIG. 4) and the second input prompt (for example, the second input prompt 463 of FIG. 4) to the second electronic device 520 to provide the first input prompt (for example, the first input prompt 461 of FIG. 4) and the second input prompt (for example, the second input prompt 463 of FIG. 4) to a generative AI model (for example, the generative AI model 470 of FIG. 4) implemented in the second electronic device 520.

For example, the generative AI model may be implemented by a hardware chip implemented in the second electronic device 520. For example, the generative AI model may be implemented by software and may be stored in the memory of the second electronic device 520. For example, the generative AI model implemented in the second electronic device 520 may include the AI model 525 that is trained to generate a personalized content based on an input prompt.

For example, the first input prompt (for example, the first input prompt 461 of FIG. 4) input to the generative AI model may include an input prompt that is generated based on the first object (for example, the first object 441 of FIG. 4).

For example, the second input prompt (for example, the second input prompt 463 of FIG. 4) input to the generative AI model may include an input prompt that is generated based on the second object (for example, the second object 443 of FIG. 4) and the personalized information (for example, the personalized information 445 of FIG. 4). For example, the second input prompt (for example, the second input prompt 463 of FIG. 4) input to the generative AI model may include at least a part of the features obtained from the image related to the user. For example, the second input prompt (for example, the second input prompt 463 of FIG. 4) input to the generative AI model may include at least a part of the information on the second object and at least a part of the personalized information.

According to an embodiment, the second electronic device 520 may transmit a third content (for example, the third content 480 of FIG. 4) output from the generative AI model (for example, the generative AI model 470 of FIG. 4) implemented in the second electronic device 520 to the first electronic device 510. For example, the second electronic device 520 may transmit the third content including at least one of a text, an image or a sound to the first electronic device 510. For example, the second electronic device 520 may transmit the third content to the first electronic device 510 in order for the first electronic device 510 to output the third content.

According to an embodiment, the first electronic device 510 may transmit the third content (for example, the third content 480 of FIG. 4) output from the generative AI model (for example, the generative AI model 470 of FIG. 4) implemented in the first electronic device 510 to the second electronic device 520. For example, the first electronic device 510 may transmit the third content including at least one of a text, an image or a sound to the second electronic device 520. For example, the first electronic device 510 may transmit the third content to the second electronic device 520 in order for the second electronic device 520 to output the third content.

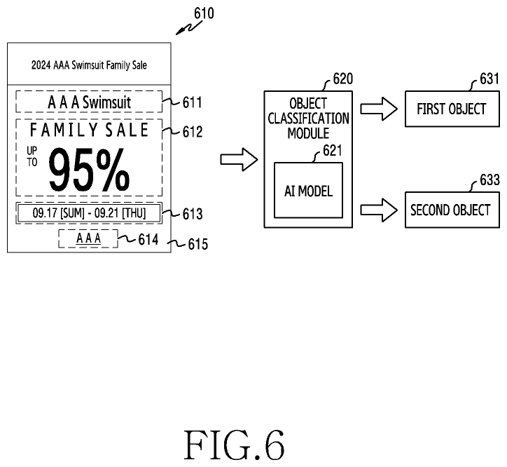

FIG. 6 is a is a diagram illustrating an electronic device classifying objects from a content according to various embodiments. Operations of the electronic device illustrated in FIG. 6 may be performed by a processor (for example, the processor 220 of FIG. 2) performing computation or by controlling components of the electronic device. An object classification module 620 of FIG. 6 may correspond to the object classification module (for example, the object classification module 420 of FIG. 4) described above with reference to FIG. 4. An AI model 621 of FIG. 6 may correspond to the AI model (for example, the AI model 421) described above with reference to FIG. 4.

According to an embodiment, the electronic device of FIG. 6 may identify objects 611, 612, 613, 614, 615 included in a first content 610 by inputting the first content 610 to the object classification module 620, and may classify the objects as a first object 631 and a second object 633. The first object 631 may include a primary object among the objects 611, 612, 613, 614, 615 of the first content 610. The second object 633 may include an additional object among the objects 611, 612, 613, 614, 615 of the first content 610.

According to an embodiment, the electronic device may provide the first content 610 to the object classification module 620. For example, the electronic device may provide the first content 610 to the object classification module 620 implemented in the electronic device as input data. For example, the electronic device may provide the first content to the object classification module 620 implemented in an external electronic device as input data by transmitting the first content to the external electronic device. For example, the electronic device may provide the first content including at least one of a text, an image or a sound to the object classification module 620.

According to an embodiment, the first content 610 may include a plurality of objects 611, 612, 613, 614, 615. For example, the first content 610 may include a first text object 611 including information on a product to be advertised. For example, the first content 610 may include a second text object 612 including information on an event. For example, the first content may include a third text object 613 including information on an event date. For example, the first content 610 may include a fourth text object 614 including information on a brand of the product. For example, the first content 610 may include a background object 615 of a background of an image.

According to an embodiment, the object classification module 620 may be implemented by hardware or software to identify objects from an input content and to classify types of objects. For example, the object classification module 620 may be implemented by a hardware chip and may be mounted in the electronic device. For example, the object classification module 620 may be implemented by software and may be stored in a memory of the electronic device.

According to an embodiment, the object classification module 620 may be implemented to perform functions of recognizing an identifier included in an input content and identifying a first object and a second object which are set based on the identifier. For example, the object classification module 620 may recognize an identifier from predetermined data among data of the first content 610. For example, the object classification module 620 may recognize an identifier included in metadata of the first content 610. For example, the identifier may be received along with the first content 610, or may be received from a server (for example, the server 108) according to a request of the first electronic device 510 or the second electronic device 520. For example, the identifier may be information that is generated by a creator or provider of the first content.

According to an embodiment, the identifier may include information and/or features related to at least one of the objects 611, 612, 613, 614, 615 included in the first content 610. For example, the identifier may include information on an appearance (for example, a size, a shape, a color) of each of the objects 611, 612, 613, 614, 615. For example, the identifier may include information on a location of each of the objects 611, 612, 613, 614, 615 in the first content 610. For example, the identifier may include information on a content of each of the objects 611, 612, 613, 614 including texts. For example, the identifier may include information on a type (for example, a primary object, an additional object) of each of the objects 611, 612, 613, 614. The above-described example is simply for explaining examples of various embodiments and the disclosure is not limited thereto.

According to an embodiment, the object classification module 620 may recognize information and/or features related to at least one object among the objects 611, 612, 613, 614, 615 included in the first content 610, based on the identifier. The object classification module 620 may recognize a type of at least one object among the objects 611, 612, 613, 614, 615 included in the first content 610, based on the identifier. The object classification module 620 may output information related to the first object 631 and/or information related to the second object 633, based on the recognized type of the object. For example, the object classification module 620 may identify at least one of an appearance (for example, a size, a shape, a color) of each of the plurality of objects 611, 612, 613, 614, 615 included in the first content 610, a location in the first content, or a content of a text, based on the identifier recognized from the metadata of the input first content 610. The object classification module 620 may identify a type of each of the plurality of objects 611, 612, 613, 614, 615 included in the first content 610, based on the identifier recognized from the metadata of the first content 610. For example, the object classification module 620 may identify the first text object 611, the second text object 612, the third text object 613, the fourth text object 614 as primary objects, based on the identifier. For example, the object classification module 620 may identify the background object 615 as an additional object based on the identifier. For example, the object classification module 620 may output information on the first text object 611, the second text object 612, the third text object 613, the fourth text object 614 (for example, information on the product to be advertised, information on the event, information on the event date, information on the brand of the product), which are identified as primary objects, as information on the first object 631, based on the identifier. For example, the object classification module 620 may output information on the background object 615 (for example, color, pattern), which is identified as an additional object, as information on the second object 633, based on the identifier.

According to an embodiment, the object classification module 620 may include the AI model 621 which is trained to identify an object from an input content and to classify a type of the object. For example, the AI model 621 may include a model that is trained to identify objects from a content through supervised learning, unsupervised learning, semi-supervised learning or reinforcement learning, and to classify types of objects. For example, the AI model 621 may include an artificial neural network including a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or one of combinations of the above-described two or more networks. The AI model 621 may include hardware or software which is implemented to perform a predetermined function. For example, the AI model 621 may be implemented by a hardware chip and may be mounted in the electronic device. For example, the AI model 621 may be implemented by software and may be stored in the memory of the electronic device.

According to an embodiment, the AI model 621 may recognize information and/or features related to at least one of the objects 611, 612, 613, 614, 615 included in the first content 610 from the identifier. The AI model 621 may recognize a type of at least one object of the objects 611, 612, 613, 614, 615 included in the first content 610. The AI model 621 may output information on the first object 631 and/or information on the second object 633, based on the recognized type of the object. For example, the AI model 621 may output information on an appearance (for example, a size, a shape, a color) of each of the objects 611, 612, 613, 614, 615 included in the first content 610. For example, the AI model 621 may output information on a location of each of the objects 611, 612, 613, 614, 615 in the first content 610. For example, the AI model 621 may output information on contents of the objects 611, 612, 613, 614 including texts.

For example, the AI model 621 may identify at least one of the appearance (for example, a size, a shape, color) of each of the plurality of objects 611, 612, 613, 614, 615 included in the first content 610, the location in the first content 610, or the content of the text, in response to the identifier related to the input first content not being identified. For example, the AI model 621 may identify types of the plurality of objects 611, 612, 613, 614, 615 included in the first content 610. For example, the AI model 621 may identify the first text object 611, the second text object 612, the third text object 613, the fourth text object 614 as primary objects. For example, the AI model 621 may identify the background object 615 as an additional object. For example, the AI model 621 may output information on the first text object 611, the second text object 612, the third text object 613, the fourth text object 614 (for example, information on the product to be advertised, information on the event, information on the event date, information on the brand of the product), which are identified as primary objects, as information on the first object 631. For example, the AI model 621 may output information on the background object 615 (for example, color, pattern, background image), which is identified as an additional object, as information on the second object 633.

According to an embodiment, the object classification module 620 may identify information on a content of each of the objects 611, 612, 613, 614 including texts as a primary object, and may identify a font, a font size, or a location of the text or each word as an additional object.

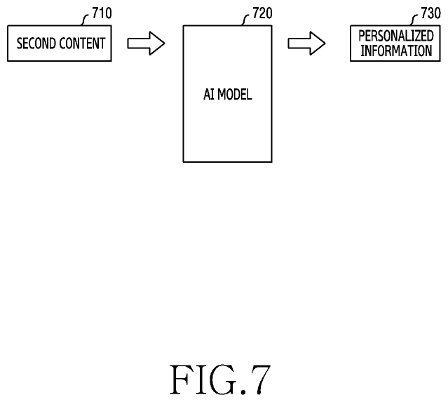

FIG. 7 is a diagram illustrating an electronic device acquiring personalized information from a content according to various embodiments. The electronic device illustrated in FIG. 7 may correspond to at least one of the electronic devices 101, 102, 104 and the server 108 described above with reference to FIGS. 1 and 2. Operations of the electronic device illustrated in FIG. 7 may be performed by a processor (for example, the processor 220 of FIG. 2) performing computation or by controlling components of the electronic device. An AI model 720 of FIG. 7 may correspond to the AI model (for example, the AI model 430) described above with reference to FIG. 4. The AI model 720 of FIG. 7 may be included in at least one of the electronic devices 101, 102, 104 and the server 108 described above with reference to FIGS. 1 and 2.

According to an embodiment, the electronic device of FIG. 7 may obtain personalized information 730 by providing a second content 710 to the AI model 720. The AI model 720 may include an AI model that is trained to obtain a weight value of each of predetermined types from a content. The electronic device may provide the second content to the AI model 720 implemented in the electronic device as input data. The electronic device may provide the second content 710 to the AI model 720 by transmitting the second content 710 to an external electronic device in which the AI model 720 is implemented.

According to an embodiment, the electronic device may provide the second content 710 related to a user to the AI model 720. For example, the electronic device may provide the second content 710 including personal identification information, such as user's name, sex, birth date, address, phone number, email address, resident registration number, to the AI model 720. For example, the electronic device may provide the second content 710 including personal body information, such as a face photo, voice information, to the AI model 720. For example, the electronic device may provide user data obtained by a user terminal to the AI model 720 as the second content 710. The user terminal may correspond to at least one of the electronic devices 101, 102, 104 described above with reference to FIGS. 1 and 2. For example, the user data may include at least one of images which are captured by the user using the user terminal, location information of the user which is obtained using a location sensor of the user terminal, voice data of the user which is obtained through a microphone of the user terminal, a pattern for using the user terminal of the user, addresses of web pages that the user visits using the electronic device, information on applications which are executed by the user in the electronic device, information on user's history of searching, activities (for example, posts, comments, messages) of the user in a social network service (SNS), or information on user's history of purchasing products. For example, the electronic device may provide image data stored in the electronic device used by the user or image data connected to a user account to the AI model 720. The electronic device used by the user may correspond to at least one of the electronic devices 101, 102, 103 described above with reference to FIGS. 1 and 2.

According to an embodiment, the electronic device may provide a content which is being replayed in the electronic device to the AI model 720 as the second content 710. For example, the electronic device may provide at least one of a video, a photo, music which is being replayed in the electronic device to the AI model 720. For example, the electronic device may provide information on an application which is executed in the electronic device (for example, an application execution time, an application execution frequency, information on a user obtained by an application) to the AI model 720.

According to an embodiment, the electronic device may provide a content to be replayed in the electronic device to the AI model 720 as the second content. For example, the electronic device may provide at least one of a video, a photo, music, a web page to be replayed in the electronic device to the AI model 720.

According to an embodiment, the electronic device may provide the second content 710 including context information to the AI model 720. The context information may include, but not be limited to, at least one of environmental information of the electronic device, state information of the electronic device, state information of the user, and schedule information of the user. For example, the electronic device may provide the AI model 720 with the second content 710 including environmental information of the electronic device, which includes weather information, place information, temperature information, humidity information, illuminance information, noise information, sound information. For example, the electronic device may provide the AI model 720 with state information of the electronic device as the second content 710, which includes mode information (for example, a sound mode, a vibration mode, a mute mode, a power-saving mode, a blocking mode, a multi-window mode, an auto-rotation mode) of the electronic device, location information of the electronic device, time information, activation information of a communication module (for example, WiFi ON/Bluetooth OFF/GPS ON/NFC ON), network access state information of the electronic device. For example, the electronic device may provide the AI model 720 with the second content 710 including state information of the user related to user's walking state, exercising state, driving state, sleeping state, mood state as information on the motion, lifestyle pattern of the user. The above-described example is simply for explaining examples of various embodiments and the disclosure is not limited thereto.

According to an embodiment, the electronic device may obtain the personalized information 730 output from the AI model 720. For example, the electronic device may obtain the personalized information 730 including at least one of information on user's sex, information on user's age, information on each of images stored in a gallery application of the user, information on user's taste, information on user' favorite color, information on user's interest, information on products that the user is interested in, information on the outfit that the user wears, information on when the user purchased the product that the user wears, information on the trend of the product that the user is interested in, information on user's path of travel, information on the weather of a region where the user is located, information on the space where the user lives or information on the product that the user uses, information on the behavior of the user using the electronic device, information on user's sleeping pattern, information on user's health. The above-described example is simply for explaining examples of various embodiments and the disclosure is not limited thereto. For example, the electronic device may obtain the personalized information 730 as a profile. The profile may include a database in which information on the user is stored. The electronic device may store the obtained personalized information in a memory.

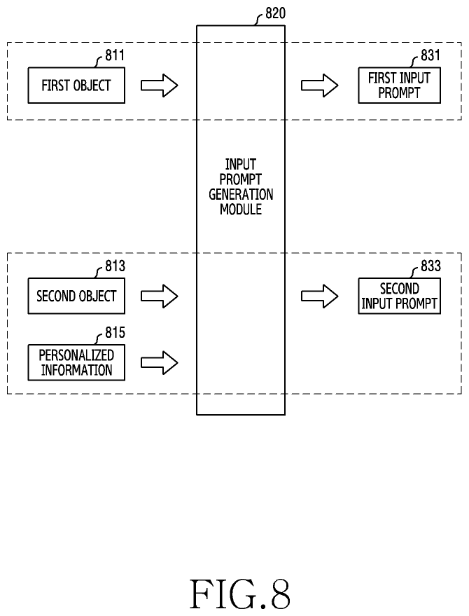

FIG. 8 is a diagram illustrating an electronic device acquiring an input prompt according to various embodiments. Operations of the electronic device illustrated in FIG. 8 may be performed by a processor (for example, the processor 220 of FIG. 2) performing computation or by controlling components of the electronic device. An input prompt generation module 820 of FIG. 8 may include hardware and/or software which is implemented to generate a prompt to be input to a generative AI model (for example, the generative AI model 470 of FIG. 4), based on input data. The input prompt generation module 820 may include an AI model that is trained to identify input data and to generate a prompt based on the input data. The AI model may include a generative AI model that is trained to generate a prompt. The input prompt generation module 820 of FIG. 8 may correspond to the input prompt generation module (the input prompt generation module 450 of FIG. 4) described above with reference to FIG. 4. An AI model included in the input prompt generation module 820 of FIG. 8 may correspond to the AI model (the AI model 451 of FIG. 4) described above with reference to FIG. 4.

According to an embodiment, the electronic device may provide a first object 811, a second object 813, and personalized information 815 to the input prompt generation module 820. For example, the electronic device may provide the first object 811, the second object 813, and the personalized information 815 to the input prompt generation module 820 as input data. For example, the electronic device may provide information on features related to each of the first object 811, the second object 813, and the personalized information 815 to the input prompt generation module 820 as input data.

According to an embodiment, the electronic device may obtain an input prompt output from the input prompt generation module 820. For example, the electronic device may obtain an input prompt which is generated by natural language of the user. For example, the electronic device may obtain an input prompt which is generated by machine language recognizable by a generative AI model. For example, the electronic device may obtain an input prompt including at least a part of an image. For example, the electronic device may obtain an input prompt including at least a part of features obtained from an image. For example, the electronic device may include information on an appearance of an object (for example, information expressed for a size, a shape, a color by a text, an image, and a line).

According to an embodiment, the input prompt generation module 820 may generate a first input prompt 831 based on the first object 811. For example, the input prompt generation module 820 may generate the first input prompt 831 including information on the appearance (for example, size, shape, color) of the first object 811. For example, the input prompt generation module 820 may generate the first input prompt 831 including information on the location of the first object 811. For example, the input prompt generation module 820 may generate the first input prompt 831 including information on the text of the first object 811. The input prompt generation module 820 may output the first input prompt 831.

According to an embodiment, the input prompt generation module 820 may generate a second input prompt 833 based on the second object 811. For example, the input prompt generation module 820 may generate the second input prompt 833 including information on the appearance (for example, size, shape, color) of the second object 813. For example, the input prompt generation module 820 may generate the second input prompt 833 including information on the location of the second object 813. For example, the input prompt generation module 820 may generate the second input prompt 831 including information on the text of the second object 811. The input prompt generation module 820 may output the second input prompt 833.

According to an embodiment, the input prompt generation module 820 may generate the second input prompt 833 based on the second object 813 and the personalized information 815. For example, the input prompt generation module 820 may generate the second input prompt 833 to cause a content in which at least a part of the second object 813 and at least a part of the personalized information 815 are combined to be generated by a generative AI model (for example, the generative AI model 470 of FIG. 4). For example, the personalized information 815 may include at least one of information on user's sex, information on user's age, information on each of images stored in a gallery application of the user, information on user's taste, information on user' favorite color, information on user's interest, information on products that the user is interested in, information on the outfit that the user wears, information on when the user purchased the product that the user wears, information on the trend of the product that the user is interested in, information on user's path of travel, information on the weather of a region where the user is located, information on the space where the user lives or information on the product that the user uses, information on the behavior of the user using the electronic device, information on user's sleeping pattern, information on user's health. For example, the input prompt generation module 820 may generate the second input prompt 833 to cause a content including the user's name obtained from the personalized information 815 and the text of the second object 813 to be generated by the generative AI model. For example, the input prompt generation module 820 may generate the second input prompt 833 to cause a content including at least a part of the image (for example, user's face, user's body, the outfit that the user wears, the product that the user purchased, the product that the user searched, the space where the user lives) of the user in at least a part of the second content to be generated by the generative AI model. According to an embodiment, the input prompt generation module 820 may generate the second input prompt 833 in relation to the personalized information 815, additionally or alternatively, based on the second content 710. The above-described example is simply for explaining examples of various embodiments and the disclosure is not limited thereto. The input prompt generation module 820 may output the generated second input prompt 833.

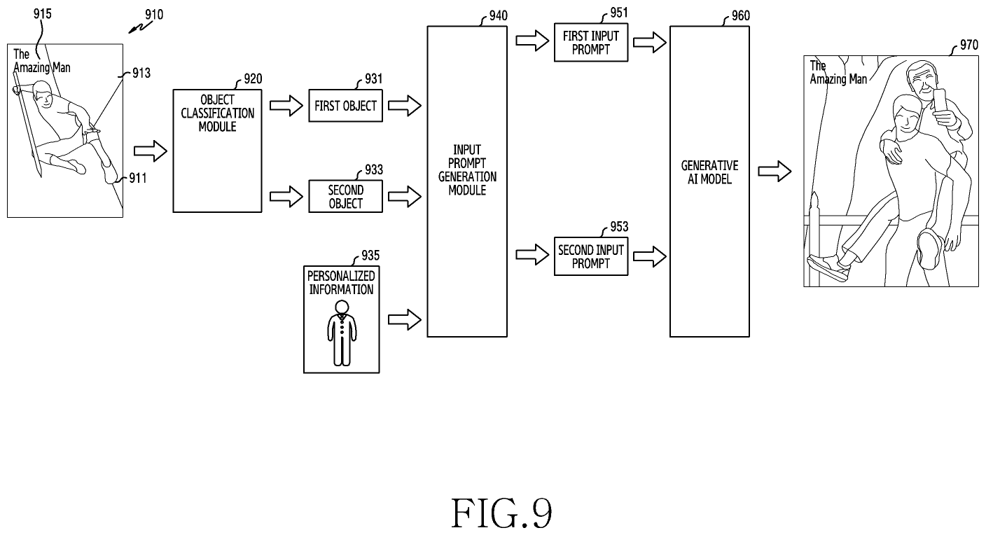

FIG. 9 is a diagram illustrating an electronic device acquiring a content using a generative AI model according to various embodiments. Operations of the electronic device illustrated in FIG. 9 may be performed by a processor (for example, the processor 220 of FIG. 2) performing computation or by controlling components of the electronic device. The operations of the electronic device illustrated in FIG. 9 may be performed by the electronic device solely or some operations may be performed through an external electronic device. A module of FIG. 9 may be implemented by hardware or software to perform a predetermined function. An AI model of FIG. 9 may include hardware or software implemented to perform a predetermined function.

According to an embodiment, a first content 910 may be input to the electronic device. For example, the first content 910 including a game advertising image may be input to the electronic device. The electronic device may provide the first content 910 to an object classification module 920. The object classification module 920 may correspond to the object classification module (object classification module 420 of FIG. 4) described above with reference to FIG. 4 and the object classification module (object classification module 620 of FIG. 6) described above with reference to FIG. 6. The first content 910 may include a character 911, a background 913, and a text 915. For example, the first content 910 may include identifiers related to the objects 911, 913, 915 included in the first content.

According to an embodiment, the electronic device may obtain information on each of the objects 911, 913, 915 included in the first content 910, which is output from the object classification module 920. For example, the electronic device may obtain information on the appearance (for example, a size, a shape, a color) of each of the character 911, the background 913, the text 915 from the object classification module 920. For example, the electronic device may obtain information on the content of the text 915 from the object classification module 920.

According to an embodiment, the electronic device may identify a first object 931 and a second object 933 among the objects included in the first content 910. The first object 931 may include an object that is classified as a primary object of the first content 910. The second object 933 may include an object that is classified as an additional object of the first content 910. The electronic device may identify the first object 931 and the second object 933, based on information on classified types of the plurality of objects of the first content 910, which are output from the object classification module 920. For example, the electronic device may identify the character 911, the text 915 as the first object 931. For example, the electronic device may obtain a feature that the character 911 is located in the center of the screen and wears a suit and a mask in red and blue colors, as a result of identifying the character 911. In addition, the electronic device may identify that the “face and costume are unchangeable and the pose is changeable” as an attribute related to the character 911. For example, as a result of identifying the text 915, the electronic device may obtain a feature that the words “The Amazing MAN” have Sanskrit fonts and a font size of 15 and are placed on the left, and an attribute of being “unchangeable”. For example, the electronic device may identify the background 913 as the second object 933. For example, as a result of identifying the background 913, the electronic device may obtain a feature of a cityscape including a skyline of a plurality of buildings.

According to an embodiment, the electronic device may provide the first object 931, the second object 933, and personalized information 935 to an input prompt generation module 940. The personalized information 935 may include information that is obtained based on a second content from an AI model that is trained to obtain a weight value on each of predetermined types from a content. The AI model may correspond to the AI model (for example, the AI model 430 of FIG. 4) described above with reference to FIG. 4 and the AI model (for example, the AI model 720 of FIG. 7) described above with reference to FIG. 7. The personalized information 935 may include information relevant to the user based on user's interest, preference, need, situation. For example, the personalized information 935 may include information on at least a part of user's face and body.

According to an embodiment, the electronic device may obtain an input prompt output from the input prompt generation module 940. The input prompt generation module 940 may correspond to the input prompt generation module (for example, the input prompt generation module 450 of FIG. 4) described above with reference to FIG. 4 and the input prompt generation module (for example, the input prompt generation module 820 of FIG. 8) described above with reference to FIG. 8.

According to an embodiment, the electronic device may obtain a first input prompt 951 output from the input prompt generation module 940 based on the first object 931. For example, the electronic device may obtain the first input prompt 951 including information on the appearance of the character (for example, a size, a shape, a color) and the attribute (for example, information on a changeable/unchangeable object) from the character 911. For example, the electronic device may obtain the first input prompt 951 including the content of the text 915. For example, the electronic device may obtain the first input prompt 951 such as “[Object 1] A character being located in the center of the screen and wearing a suit and a mask in red and blue colors, [Object 1 attribute] The costume and face of the first object being unchangeable and the pose being changeable, [Object 2] The words “The Amazing MAN” having Sanskrit fonts and a font size of 15 being placed on the upper end and aligned with the left, [Object 2 attribute] Unchangeable”.

According to an embodiment, the electronic device may obtain a second input prompt 953 output from the input prompt generation module 940 based on the second object 933 and the personalized information 935. For example, the electronic device may obtain the second input prompt 953 including information on user's face. For example, the electronic device may obtain the second input prompt 953 including information on user's body. For example, the electronic device may obtain the second input prompt 953 including information on the outfit that the user wears. For example, the electronic device may obtain the second input prompt 953 for changing the feature (for example, color) of the background 913. For example, the electronic device may obtain the second input prompt 953 such as “[Background] A park in the autumn in the skyscrapers of a big city, [Background attribute] Changeable, [Object] Generating an image of a person's appearance located in the center of the screen using data of user's face in personalized information, [Object attribute] Changeable within data of user's face included in personalized information”.

According to an embodiment, the electronic device may provide at least a part of the first input prompt 951 and at least a part of the second input prompt 953 to a generative AI model 960. The generative AI model 960 may include an AI model that is trained to create a personalized content. The generative AI model 960 may correspond to the generative AI model (for example, the generative AI model 470 of FIG. 4) described above with reference to FIG. 4. For example, the electronic device may provide at least a part of the first input prompt 951 including the information on the appearance (for example, a size, a shape, a color) of the character 911 and the content of the text 915 to the generative AI model 960. For example, the electronic device may provide at least a part of the second input prompt 953 including information on user's face and skeleton and information on the color of the background to the generative AI model 960. For example, the electronic device may provide the generative AI model 960 with an input prompt such as “[Object 1] A character being located in the center of the screen and wearing a suit and a mask in red and blue colors, [Object 1 attribute] The costume and face of the first object being unchangeable and the pose being changeable, [Object 2] The words “The Amazing MAN” having Sanskrit fonts and a font size of 15 being placed on the upper end and aligned with the left, [Object 2 attribute] Unchangeable, [Background] A park in the autumn in the skyscrapers of a big city, [Background attribute] Changeable to an autumn park image included in personalized information, [Object 3] Generating an image of a person's appearance located in the center of the screen using data of user's face in personalized information, [Object 3 attribute] Changeable within data of user's face included in personalized information”. According to an embodiment, the electronic device may obtain a third content 970 output from the generative AI model 960. For example, the electronic device may obtain the third content 970 output from the generative AI model 960 based on at least a part of the first input prompt 951 and at least a part of the second input prompt 953. For example, the electronic device may obtain the third content 970 including the character, a part of the user's face and body and the text. For example, the electronic device may obtain the third content 970 including the user riding on the character and the game title to correspond to the first input prompt 951 and the second input prompt 953 input to the generative AI model 960.

According to an embodiment, the electronic device may output the third content 970. For example, the electronic device may output the third content 970 using at least one of a display, an audio module of the electronic device. For example, the electronic device may transmit the third content 970 to an external electronic device to output the third content 970 using at least one of a display, an audio module of the external electronic device.

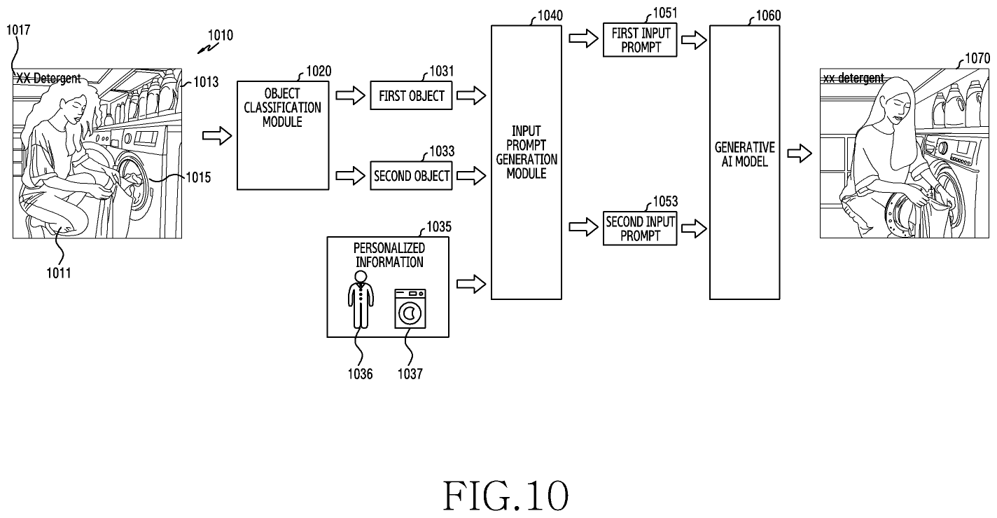

FIG. 10 is a diagram illustrating an electronic device acquiring a content using a generative AI model according to various embodiments. Operations of the electronic device illustrated in FIG. 10 may be performed by a processor (for example, the processor 220 of FIG. 2) performing computation or by controlling components of the electronic device. The operations of the electronic device illustrated in FIG. 10 may be performed by the electronic device solely or some operations may be performed through an external electronic device. A module of FIG. 10 may be implemented by hardware or software to perform a predetermined function. An AI model of FIG. 10 may include hardware or software implemented to perform a predetermined function.

According to an embodiment, a first content 1010 may be input to the electronic device. For example, the first content 1010 including a product advertising image may be input to the electronic device. The electronic device may provide the first content 1010 to an object classification module 1020. The object classification module 1020 may correspond to the object classification module (object classification module 420 of FIG. 4) described above with reference to FIG. 4 and the object classification module (object classification module 620 of FIG. 6) described above with reference to FIG. 6. The first content 1010 may include a person 1011, a first product 1013, a second product 1015, and a text 1017. For example, the first content 1010 may include identifiers related to the objects 1011, 1013, 1015, 1017 included in the first content 1010.

According to an embodiment, the electronic device may obtain information on each of the objects 1011, 1013, 1015, 1017 included in the first content 1010, which is output from the object classification module 1020. For example, the electronic device may obtain information on an appearance (for example, a size, a shape, a color) of each of the person 1011, the first product 1013, the second product 1015, the text 1017 from the object classification module 1020. For example, the electronic device may obtain information on a content of the text 1017 from the object classification module 1020. For example, as a result of identifying the first product 1013, the electronic device may obtain a feature of a detergent container which is located on the right upper end of the screen, and has a blue body, an orange lid, and a red logo. The electronic device may identify an attribute that the first product 1013 is unchangeable. For example, as a result of identifying the text 1017, the electronic device may obtain a feature that the words “XX detergent” is located on the left upper end and is aligned with the left with Sanskrit fonts and a font size of 15. The electronic device may identify an attribute that the text 1017 is unchangeable. For example, as a result of identifying the person 1011, the electronic device may obtain a feature that the person is located in the center of the left of the screen and is putting laundry while sitting with her right face exposed. The electronic device may identify an attribute that the person 1011 is changeable within data of user's face included in personalized information. For example, as a result of identifying the second product 1015, the electronic device may obtain a feature of a washing machine which is located in the center of the right of the screen and has white color. The electronic device may identify an attribute that model name AA, block color are fixed and the product direction is changeable for the second product 1015.

According to an embodiment, the electronic device may identify a first object 1031 and a second object 1033 among the objects included in the first content 1010. For example, the electronic device may identify the first product 1013 and the text 1017 as the first objects 1031. For example, the electronic device may identify the person 1011, the second product 1015 as the second objects 1033.

According to an embodiment, the electronic device may provide the first object 1031, the second object 1033, and personalized information 1035 to an input prompt generation module 1040. The personalized information 1035 may include information that is obtained based on a second content from an AI model that is trained to obtain a weight value on each of predetermined types from a content. The AI model may correspond to the AI model (for example, the AI model 430 of FIG. 4) described above with reference to FIG. 4 and the AI model (for example, the AI model 720 of FIG. 7) described above with reference to FIG. 7. For example, the personalized information 1035 may include information relevant to the user based on user's interest, preference, need, situation. For example, the personalized information 1035 may include information 1036 on at least a part of user's face and body. For example, the personalized information 1035 may include information 1037 on the washing machine that the user uses.

According to an embodiment, the electronic device may obtain an input prompt output from the input prompt generation module 1040. The input prompt generation module 1040 may correspond to the input prompt generation module (for example, the input prompt generation module 450 of FIG. 4) described above with reference to FIG. 4 and the input prompt generation module (for example, the input prompt generation module 820 of FIG. 8) described above with reference to FIG. 8.

According to an embodiment, the electronic device may obtain a first input prompt 1051 output from the input prompt generation module 1040 based on the first object 1031. For example, the electronic device may obtain the first input prompt 1051 including information on the appearance (for example, a size, a shape, a color) and location of the first product 1013. For example, the electronic device may obtain the first input prompt 1051 including the content of the text 1017. For example, the electronic device may obtain the first input prompt 1051 such as “[Object 1] A detergent container which is located on the right upper end of the screen, and has a blue body, an orange lid, and a red logo, [Object 1 attribute] Unchangeable, [Object 2] The words “XX detergent” being located on the left upper end and aligned with the left with Sanskrit fonts and a font size of 15, [Object 2 attribute] Unchangeable”.

According to an embodiment, the electronic device may obtain a second input prompt 1053 output from the input prompt generation module 1040 based on the second object 1033 and the personalized information 1035. For example, the electronic device may obtain the second input prompt 1053 including information on user's face. For example, the electronic device may obtain the second input prompt 1053 including information on user's body. For example, the electronic device may obtain the second input prompt 1053 including information on the outfit that the user wears. For example, the electronic device may obtain the second input prompt 1053 including information on the appearance (for example, a size, a shape, a color), the model name of the product that the user uses. For example, the electronic device may obtain the second input prompt 1053 including information on the appearance (for example, a size, a shape, a color), the model name, and the location of the second product. For example, the electronic device may obtain the second input prompt 1053 such as “[Background] An image of a laundry room of an apartment including a pantry, [Background attribute] Changeable to a laundry room image included in personalized information, [Object 3] Generating an image of a person located in the center of the left side of the screen, and putting laundry while sitting, using data showing user's right face in the personalized information, [Object 3 attribute] Changeable within data of user's face included in the personalized information, [Object 4] Generating an image of a washing machine located in the center of the right of the screen, having model name AA, black color, [Object 4 attribute] Color and model name being unchangeable, Product direction changeable”.

According to an embodiment, the electronic device may provide the first input prompt 1051 and the second input prompt 1053 to a generative AI model 1060. The generative AI model 1060 may include an AI model that is trained to create a personalized content. The generative AI model 1060 may correspond to the generative AI model (for example, the generative AI model 470 of FIG. 4) described above with reference to FIG. 4. For example, the electronic device may provide at least a part of the first input prompt 1051 including the information on the appearance (for example, a size, a shape, a color) and location of the first product 1013, the information on the content of the text 1017 to the generative AI model 1060. For example, the electronic device may provide at least a part of the second input prompt 1053 including information on user's face and skeleton, information on the appearance, model name of the product that the user uses, and information on the appearance (for example, a size, a shape, a color), location of the second product to the generative AI model 960. For example, the electronic device may provide the generative AI model 1060 with an input prompt such as “[Object 1] A detergent container which is located on the right upper end of the screen, and has a blue body, an orange lid, and a red logo, [Object 1 attribute] Unchangeable, [Object 2] The words “XX detergent” being located on the left upper end and aligned with the left with Sanskrit fonts and a font size of 15, [Object 2 attribute] Unchangeable, [Background] An image of a laundry room of an apartment including a pantry, [Background attribute] Changeable to a laundry room image included in personalized information, [Object 3] Generating an image of a person located in the center of the left side of the screen, and putting laundry while sitting, using data showing user's right face in the personalized information, [Object 3 attribute] Changeable within data of user's face included in the personalized information, [Object 4] Generating an image of a washing machine located in the center of the right of the screen, having model name AA, black color, [Object 4 attribute] Color and model name being unchangeable, Product direction changeable”.

According to an embodiment, the electronic device may obtain a third content 1070 output from the generative AI model 1060. For example, the electronic device may obtain the third content 1070 output from the generative AI model 1060 based on at least a part of the first input prompt 1051 and at least a part of the second input prompt 1053. For example, the electronic device may obtain the third content 1070 including the product name, the advertising product, a part of user's face and body, and the washing machine that the user uses.

According to an embodiment, the electronic device may output the third content 1070. For example, the electronic device may output the third content 1070 using at least one of a display, an audio module of the electronic device. For example, the electronic device may transmit the third content 1070 to an external electronic device to output the third content 1070 using at least one of a display, an audio module of the external electronic device.

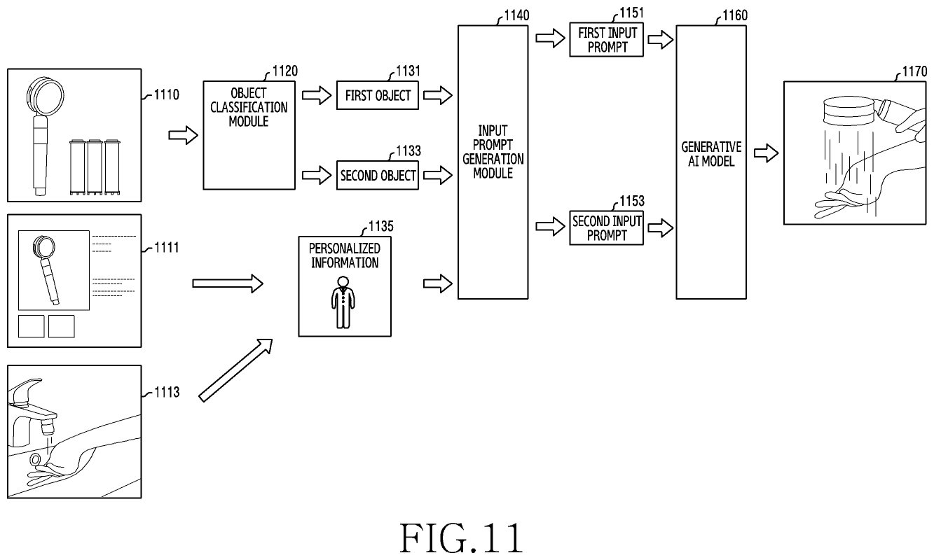

FIG. 11 is a diagram illustrating an electronic device acquiring a content using a generative AI model according to various embodiments. Operations of the electronic device illustrated in FIG. 11 may be performed by a processor (for example, the processor 220 of FIG. 2) performing computation or by controlling components of the electronic device. The operations of the electronic device illustrated in FIG. 11 may be performed by the electronic device solely or some operations may be performed through an external electronic device. A module of FIG. 11 may be implemented by hardware or software to perform a predetermined function. An AI model of FIG. 11 may include hardware or software implemented to perform a predetermined function.

According to an embodiment, a first content 1110 may be input to the electronic device. For example, the first content 1110 including a product advertising image may be input to the electronic device.

According to an embodiment, the electronic device may provide the first content 1110 to an object classification module 1120. The object classification module 1120 may correspond to the object classification module (object classification module 420 of FIG. 4) described above with reference to FIG. 4 and the object classification module (object classification module 620 of FIG. 6) described above with reference to FIG. 6. The first content 1110 may include identifiers related to objects 1011, 1013, 1015, 1017 included in the first content 1110. According to an embodiment, the electronic device may obtain information on each of the objects included in the first content 1110, which is output from the object classification module 1120. For example, the electronic device may obtain information on appearances (for example, a size, a shape, a color) of a first object, a second object, and a background included in the first content 1110 from the object classification module 1020. For example, as a result of identifying the first object, the electronic device may obtain a feature of a semi-transparent shower including a filter in a handle. The electronic device may identify an attribute that the first object is unchangeable first object. For example, as a result of identifying the second object, the electronic device may obtain a feature of a filter for a shower. The electronic device may identify an attribute that the second object is changeable and erasable. For example, the electronic device may obtain a feature on a yellow background. The electronic device may identify an attribute that the background is changeable.

According to an embodiment, the electronic device may identify a first object 1131 and a second object 1133 among the objects included in the first content 1110. For example, the electronic device may identify the first object 1131 and the second object 1133 which are classified by the object classification module 1120 based on identifiers. For example, the electronic device may identify the first object 1131 and the second object 1133 which are classified by an AI model which is trained to identify objects included in a content and to classify types. For example, the electronic device may identify the shower of the first content 1110 as the first object 1131. For example, the electronic device may identify the filter and the background of the first content 1110 as the second object 1133.

According to an embodiment, the electronic device may obtain personalized information from a plurality of contents 1111, 1113. The personalized information 1135 may include information that is obtained based on a second content from an AI model which is trained to obtain a weight value of each of predetermined types from a content. The AI model may correspond to the AI model (for example, the AI model 430 of FIG. 4) described above with reference to FIG. 4 and the AI model (for example, the AI model 720 of FIG. 7) described above with reference to FIG. 7. For example, the personalized information 1135 may include information relevant to the user based on user's interest, preference, need, situation. For example, the personalized information 1135 may include information on at least a part of user's face and body. For example, the electronic device may obtain the personalized information from a content (for example, a video, a photo, music, a web page, an application) which is being replayed in the electronic device. For example, the electronic device may obtain the personalized information from a content to be replayed (for example, a video, a photo, music, a web page, an application). For example, the electronic device may obtain the personalized information from context information (for example, location information, information on a screen which is being displayed by the electronic device, environmental information of the electronic device, state information of the electronic device, state information of the user, or schedule information of the user) which is obtained by the user using the electronic device. For example, the electronic device may obtain personalized information on the product that the user is interested in, from a home page 1111 which is selling the filter that the electronic device displays. For example, the electronic device may obtain personalized information on the appearance of a part of user's body from an image 1113 of the user washing hands, which is stored in a user's gallery.

According to an embodiment, the electronic device may provide the first object 1131, the second object 1133, and the personalized information 1135 to an input prompt generation module 1140. For example, the electronic device may provide the feature of the shower identified from the first content 1110 as the primary object to the input prompt generation module 1140. For example, the electronic device may provide features of the filter and the background identified from the first content 1110 as additional objects to the input prompt generation module 1140. For example, the electronic device may provide the feature of the image including user's hand to the input prompt generation module 1140 as the personalized information 1135.

According to an embodiment, the electronic device may obtain an input prompt output from the input prompt generation module 1140. The input prompt generation module 1140 may correspond to the input prompt generation module (for example, the input prompt generation module 450 of FIG. 4) described above with reference to FIG. 4 and the input prompt generation module (for example, the input prompt generation module 820 of FIG. 8) described above with reference to FIG. 8.

According to an embodiment, the electronic device may obtain a first input prompt 1151 output from the input prompt generation module 1140, based on the first object 1131 included in the first content 1110. For example, the electronic device may obtain the first input prompt 1151 including information on the appearance (for example, a size, a shape, a color) of the shower. For example, the electronic device may obtain the first input prompt 1151 such as “[Object] An image of a semi-transparent shower having a filter in a handle, [Object attribute] Unchangeable”.

According to an embodiment, the electronic device may obtain a second input prompt 1153 output from the input prompt generation module 1140, based on the second object 1133 and the personalized information 1135. For example, the electronic device may obtain the second input prompt 1153 including information on user's body. For example, the electronic device may obtain the second input prompt 1153 including information on the outfit that the user wears. For example, the electronic device may obtain the second input prompt 1153 including information on the color of the background. For example, the electronic device may obtain the second input prompt 1153 such as “[Object] Generating an image of washing hand using an image showing user's hand among user images, [Object attribute] Pose being changeable, [Background] Blue, [Background attribute] Changeable”.

According to an embodiment, the electronic device may provide the first input prompt 1151 and the second input prompt 1153 to a generative AI model 1160. The generative AI model 1160 may include an AI model that is trained to create a personalized content. The generative AI model 1160 may correspond to the AI model (for example, the AI model 470 of FIG. 4) described above with reference to FIG. 4. For example, the electronic device may provide at least a part of the first input prompt 1151 including information on the appearance (for example, a size, a shape, a color) of a filter for tap water to the generative AI model 1160. For example, the electronic device may provide the generative AI model 1160 with at least a part of the second input prompt 1153 including information on user's body, information on the outfit that the user wears, information on user's favorite color. For example, the electronic device may provide the generative AI model 1160 with an input prompt such as “[Object 1] An image of a semi-transparent shower having a filter in a handle, [Object 1 attribute] Unchangeable, [Object 2] Generating an image of washing hand using an image showing user's hand among user images, [Object 2 attribute] Pose being changeable, [Background] Blue, [Background attribute] Changeable”.

According to an embodiment, the electronic device may obtain a third content 1170 output from the generative AI model 1160. For example, the electronic device may obtain the third content 1170 output from the generative AI model 1160 based on at least a part of the first input prompt 1151 and at least a part of the second input prompt 1153. For example, the electronic device may obtain the third content 1170 including a shower, user's hand, a background of user's favorite color.

According to an embodiment, the electronic device may output the third content 1170. For example, the electronic device may output the third content 1170 using at least one of a display, an audio module of the electronic device. For example, the electronic device may transmit the third content 1170 to an external electronic device to output the third content 1170 using at least one of a display, an audio module of the external electronic device.

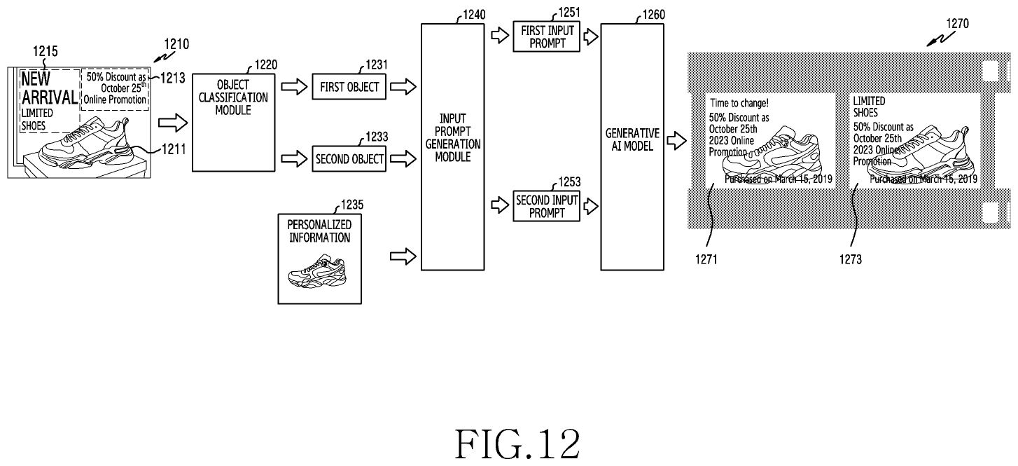

FIG. 12 is a diagram illustrating an electronic device acquiring a content using a generative AI model according to various embodiments. Operations of the electronic device illustrated in FIG. 12 may be performed by a processor (for example, the processor 220 of FIG. 2) performing computation or by controlling components of the electronic device. The operations of the electronic device illustrated in FIG. 12 may be performed by the electronic device solely or some operations may be performed through an external electronic device. A module of FIG. 12 may be implemented by hardware or software to perform a predetermined function. An AI model of FIG. 12 may include hardware or software implemented to perform a predetermined function.

According to an embodiment, a first content 1210 may be input to the electronic device. For example, the first content 1210 including a product advertising image may be input to the electronic device. The electronic device may provide the first content 1210 to an object classification module 1220. The object classification module 1220 may correspond to the object classification module (object classification module 420 of FIG. 4) described above with reference to FIG. 4 and the object classification module (object classification module 620 of FIG. 6) described above with reference to FIG. 6. The first content 1210 may include a product 1211, a first text 1213, and a second text 1215. For example, the first content 1210 may include identifiers related to the objects 1211, 1213, 1215 included in the first content 1210.

According to an embodiment, the electronic device may obtain information on each of the objects 1211, 1213, 1215 included in the first content 1210, which is output from the object classification module 1220. For example, the electronic device may obtain information on appearances (for example, a size, a shape, a color) of the product 1211, the first text 1213, and the second text 1215 from the object classification module 1220. The electronic device may obtain information on the contents of the first text 1213, the second text 1215 from the object classification module 1220. For example, as a result of identifying the product 1211, the electronic device may obtain a feature of a shoe located on the bottom of the center of the screen. The electronic device may identify an attribute that the product 1211 is unchangeable. For example, the electronic device may identify an attribute that the location and/or size of the product 1211 is unchangeable and the shape, appearance, image of the product 1211 are changeable. For example, the electronic device may identify an attribute that the product 1211 is unchangeable within a predetermined frame of a video. For example, the electronic device may identify an attribute that the location and shape of the product are unchangeable within a predetermined frame of the video, and the product is changeable to a shape and a design of an object that is obtained from personalized information or a content other than the first content 1210 in frames other than the predetermined frame.

For example, as a result of identifying the first text 1213, the electronic device may obtain a feature that the text is located at the upper right end of the screen and has a font size of 10 and says “50% discount as an October 25^{th} online promotion”. The electronic device may identify an attribute of the first text 1213 that the font size and color are changeable and the content is unchangeable. For example, as a result of identifying the second text 1215, the electronic device may obtain a feature that the font size is 15 and the content is “NEW ARRIVAL”, and the font size is 12 and the content is “LIMITED SHOES”. The electronic device may identify an attribute that the second text 1215 is “changeable”.

According to an embodiment, the electronic device may identify a first object 1231 and a second object 1233 among the objects included in the first content 1210. For example, the electronic device may identify the product 1211 and the first text 1213 as the first object 1231. For example, the electronic device may identify the second text 1215 as the second object 1233.

According to an embodiment, the electronic device may provide the first object 1231, the second object 1233, and personalized information 1235 to an input prompt generation module 1240. The personalized information 1235 may include information that is obtained based on a second content from an AI model which is trained to obtain a weight value of each of predetermined types from a content. The AI model may correspond to the AI model (for example, the AI model 430 of FIG. 4) described above with reference to FIG. 4, and the AI model (for example, the AI model 720 of FIG. 7) described above with reference to FIG. 7. For example, the personalized information 1235 may include information relevant to the user based on user's interest, preference, need, situation. For example, the personalized information 1235 may include information on the sneakers that the user uses.

According to an embodiment, the electronic device may obtain an input prompt output from the input prompt generation module 1240. The input prompt generation module 1240 may correspond to the input prompt generation module (for example, the input prompt generation module 450 of FIG. 4) described above with reference to FIG. 4 and the input prompt generation module (for example, the input prompt generation module 820 of FIG. 8) described above with reference to FIG. 8.

According to an embodiment, the electronic device may obtain a first input prompt 1251 output from the input prompt generation module 1240 based on the first object 1231. For example, the electronic device may obtain the first input prompt 1251 including information on the appearance (for example, a size, a shape, a color) and the location of the product 1211. For example, the electronic device may obtain the first input prompt 1251 including the appearance (for example, a size, a shape, a color), the content, and the location of the first text 1213. For example, the electronic device may obtain the first input prompt 1251 such as “[Object] An image of a shoe located on the bottom of the center of the screen, [Object attribute] Location and shape being unchangeable within frame 1 of a video, shape and design of the object being changeable in frames other than frame 1, [Text] 50% discount as an October 25th online promotion, [Text attribute] Font size and color being changeable, content being unchangeable”.

According to an embodiment, the electronic device may obtain a second input prompt 1253 output from the input prompt generation module 1240, based on the second object 1233 and the personalized information 1235. For example, the electronic device may obtain the second input prompt 1253 including information related to the appearance (for example, a size, a shape, a color), the date of purchase, and the model of shoes that the user wears. For example, the electronic device may obtain the second input prompt 1253 including at least a part of the content of the second text 1215. For example, the electronic device may obtain the second input prompt 1253 such as “[Object] User's shoes, included in personalized information, being located on the bottom of the center of the screen, [Object attribute] Model being unchangeable, changeable to a worn-out appearance, [Text] LIMITED SHOES, [Text attribute] Font size and color being changeable”.

According to an embodiment, the electronic device may provide the first input prompt 1251 and the second input prompt 1253 to a generative AI model 1260. The generative AI model 1260 may include an AI model that is trained to generate a personalized content. The generative AI model 1260 may correspond to the generative AI model (for example, the generative AI model 470 of FIG. 4) described above with reference to FIG. 4. For example, the electronic device may provide the generative AI model 1260 with at least a part of the first input prompt 1251 including information on the appearance (for example, a size, a shape, a color) and the location of the product 1211. For example, the electronic device may provide the generative AI model 1260 with at least a part of the second input prompt 1253 including information on the appearance (for example, a size, a shape, a color) of the shoes that the user wears, the date of purchase, and the model, and the content of the second text 1215. For example, the electronic device may provide the generative AI model 1260 with an input prompt such as “Create a video having a first frame and a second frame, “[First frame object] User's shoes, included in personalized information, being located on the bottom of the center of the screen, [First frame object attribute] Model being unchangeable, changeable to a worn-out appearance, [First frame text] LIMITED SHOES, [First frame text attribute] Font size and color being changeable, [Second frame object] An image of a shoe of model XX located on the bottom of the center of the screen, [Second frame object attribute] Unchangeable, [Second frame text] 50% discount as an October 25th online promotion, [Second frame text attribute] Font size and color being changeable, content being unchangeable”.

According to an embodiment, the electronic device may obtain a third content output from the generative AI model 1260. For example, the electronic device may obtain the third content 1270 output from the generative AI model 1260 based on at least a part of the first input prompt 1251 and at least a part of the second input prompt 1253. For example, the electronic device may obtain the third content 1270 created as a video. For example, the electronic device may obtain, as the third content 1270, a video content including a first frame 1271 including the sneakers that the user wears as an object and a second frame 1273 including the product 1211 as an object.

According to an embodiment, the electronic device may output the third content 1270. For example, the electronic device may output the third content 1270 using at least one of a display, an audio module of the electronic device. For example, the electronic device may transmit the third content 1270 to an external electronic device to output the third content 1270 using at least one of a display, an audio module of the external electronic device.

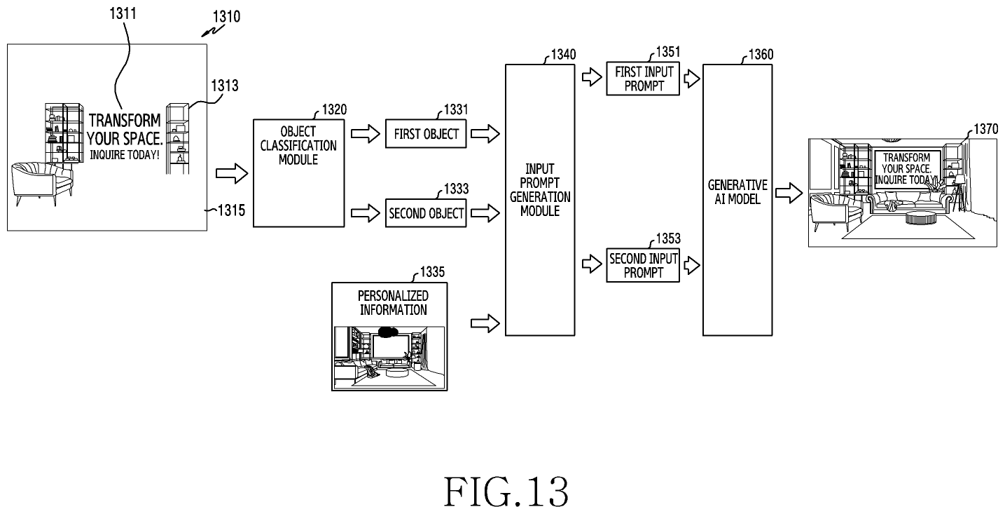

FIG. 13 is a diagram illustrating an electronic device acquiring a content using a generative AI model according to various embodiments. Operations of the electronic device illustrated in FIG. 13 may be performed by a processor (for example, the processor 220 of FIG. 2) performing computation or by controlling components of the electronic device. The operations of the electronic device illustrated in FIG. 13 may be performed by the electronic device solely or some operations may be performed through an external electronic device. A module of FIG. 13 may be implemented by hardware or software to perform a predetermined function. An AI model of FIG. 13 may include hardware or software implemented to perform a predetermined function.

According to an embodiment, a first content 1310 may be input to the electronic device. For example, the first content 1310 including a product advertising phrase and a product image may be input to the electronic device. The electronic device may provide the first content 1310 to an object classification module 1320. The object classification module 1320 may correspond to the object classification module (object classification module 420 of FIG. 4) described above with reference to FIG. 4 and the object classification module (object classification module 620 of FIG. 6) described above with reference to FIG. 6. The first content 1310 may include a text 1311, a product 1313, a background 1315. For example, the first content 1310 may include identifiers related to the objects 1311, 1313, 1315 included in the first content 1310.

According to an embodiment, the electronic device may obtain information on each of the objects included in the first content 1310, which is output from the object classification module 1320. For example, the electronic device may obtain information on appearances (for example, a size, a shape, a color) of the text 1311, the product 1313, the background 1315 from the object classification module 1320. For example, as a result of identifying the text 1311, the electronic device may identify a feature that “TRANSFORM YOUR SPACE. INQUIRE TODAY!” is located in the center of the first content 1310, the font size of “TRANSFORM YOUR SPACE” is 20, and the font size of “INQUIRE TODAY!” is 10. The electronic device may identify an attribute that the font size and the font of the text are changeable. For example, as a result of identifying the product 1313, the electronic device may obtain a feature of open-type 5-layer cabinets located on both sides of the first content 1310. The electronic device may identify an attribute that the product 1313 is unchangeable. For example, as a result of identifying the background 1315, the electronic device may identify features related to the appearance of walls, floor, ceiling, pillars. The electronic device may identify an attribute that the locations of the walls and pillars are unchangeable and the others are changeable.

According to an embodiment, the electronic device may identify a first object 1331 and a second object 1333 among the objects included in the first content 1310. For example, the electronic device may identify the text 1311, the product 1313 as the first object 1331. For example, the electronic device may identify the background 1315 as the second object 1333.

According to an embodiment, the electronic device may provide the first object 1331, the second object 1333, and personalized information 1335 to an input prompt generation module 1340. The personalized information 1335 may include information that is obtained based on a second content from an AI model which is trained to obtain a weight value on each of predetermined types from a content. The AI model may correspond to the AI model (for example, the AI model 430 of FIG. 4) described above with reference to FIG. 4, and the AI model (for example, the AI model 720 of FIG. 7) described above with reference to FIG. 7. For example, the personalized information 1335 may include information relevant to the user based on user's interest, preference, need, situation. For example, the personalized information 1335 may include information on user's living spaces. For example, the personalized information may include information on the product that the user uses.

According to an embodiment, the personalized information 1335 may be obtained from an image which is captured in a place the user lives in or frequently visits. For example, the feature of a subject recognized from the image which is captured in user's living place may be included in the personalized information 1335. According to an embodiment, the personalized information 1335 may be obtained from an image that is captured by the user. For example, the feature of a subject recognized from the image captured by the user or the appearance of the user recognized from the image captured by the user may be included in the personalized information 1335.

According to an embodiment, the electronic device may obtain an input prompt output from the input prompt generation module 1340. The input prompt generation module 1340 may correspond to the input prompt generation module (for example, the input prompt generation module 450 of FIG. 4) described above with reference to FIG. 4 and the input prompt generation module (for example, the input prompt generation module 820 of FIG. 8) described above with reference to FIG. 8.

According to an embodiment, the electronic device may obtain a first input prompt 1351 output from the input prompt generation module 1340, based on the first object 1331. For example, the electronic device may obtain the first input prompt 1351 including information on the text 1311 and the appearance (for example, a size, a shape, a color) and the location of the product 1313. For example, the electronic device may obtain the first input prompt 1351 such as “[Text] TRANSFORM OUR SPACE. INQUIRE TODAY! being positioned in the center of the image, [Text attribute] Font size, font being changeable, [Product] Open-type 5-layer cabinets being disposed on both sides of the image, [Product attribute] Unchangeable”.

According to an embodiment, the electronic device may obtain a second input prompt 1353 output from the input prompt generation module 1340, based on the second object 1333 and the personalized information. For example, the electronic device may obtain the second input prompt 1353 including information 1335 on user's living space. For example, the electronic device may obtain the second input prompt 1353 including information on the product that the user uses. For example, the electronic device may obtain the second input prompt 1353 such as “[Floor] Rug, sofa, round table being positioned, [Floor attribute] Changeable, [Wall] Stone grey color, the front wall with a frame configuration in white color, [Wall attribute] Changeable, [Pillar] Stone gray color, harmonizing with the wall, [Pillar attribute] Changeable”.

According to an embodiment, the electronic device may provide the first input prompt 1351 and the second input prompt 1353 to a generative AI model 1360. The generative AI model 1360 may include an AI model that is trained to generate a personalized content. The generative AI model 1360 may correspond to the generative AI model (for example, the generative AI model 470 of FIG. 4) described above with reference to FIG. 4. For example, the electronic device may provide the generative AI model 1360 with at least a part of the first input prompt 1351 including information on the text 1311 and the appearance (for example, a size, a shape, a color) and the location of the product 1313. For example, the electronic device may provide the generative AI model 1360 with at least a part of the second input prompt 1353 including information on the user's living space and the product that the user uses. For example, the electronic device may provide the generative AI model 1360 with an input prompt such as “[Text] TRANSFORM OUR SPACE. INQUIRE TODAY! being positioned in the center of the image, [Text attribute] Font size, font being changeable, [Product] Open-type 5-layer cabinets being disposed on both sides of the image, [Product attribute] Unchangeable, [Floor] Rug, sofa, round table being positioned, [Floor attribute] Changeable, [Wall] Stone grey color, the front wall with a frame configuration in white color, [Wall attribute] Changeable, [Pillar] Stone gray color, harmonizing with the wall, [Pillar attribute] Changeable”.

According to an embodiment, the electronic device may obtain a third content 1370 output from the generative AI model 1360. For example, the electronic device may obtain the third content 1370 output from the generative AI model 1360 based on at least a part of the first input prompt 1351 and at least a part of the second input prompt 1353. For example, the electronic device may obtain, as the third content 1370, an image including the text, and the appearance of the product in user's living space.

According to an embodiment, the electronic device may output the third content 1370. For example, the electronic device may output the third content 1370 using at least one of a display, an audio module of the electronic device. For example, the electronic device may transmit the third content 1370 to an external electronic device to output the third content 1370 using at least one of a display, an audio module of the external electronic device.

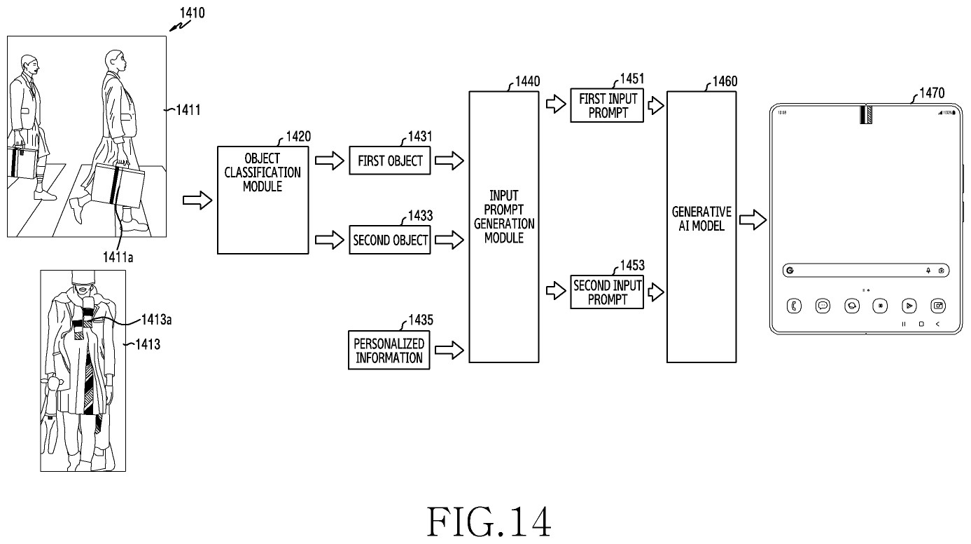

FIG. 14 is a diagram illustrating an electronic device acquiring a content using a generative AI model according to various embodiments. Operations of the electronic device illustrated in FIG. 14 may be performed by a processor (for example, the processor 220 of FIG. 2) performing computation or by controlling components of the electronic device. The operations of the electronic device illustrated in FIG. 14 may be performed by the electronic device solely or some operations may be performed through an external electronic device. A module of FIG. 14 may be implemented by hardware or software to perform a predetermined function. An AI model of FIG. 14 may include hardware or software implemented to perform a predetermined function.

According to an embodiment, a plurality of contents 1410 may be input to the electronic device. For example, one or more images of a first image 1411 including a key visual of a brand, a second image 1413 may be input to the electronic device.

According to an embodiment, the electronic device may input the plurality of contents 1410 to an object classification module 1420. The object classification module 1420 may correspond to the object classification module (for example, the object classification module 420 of FIG. 4) described above with reference to FIG. 4, and the object classification module (for example, the object classification module 620 of FIG. 6) described above with reference to FIG. 6. The plurality of contents 1410 may include objects related to one another. For example, the first image 1411 and the second image 1413 may include color patterns of the brand as interrelated objects. For example, each of the first image 1411, the second image 1413 may include identifiers related to objects included in the first image 1411, the second image 1413.

According to an embodiment, the electronic device may obtain information on each of the objects included in the plurality of contents 1410, which are output from the object classification module 1420. For example, the electronic device may obtain information on an appearance (for example, a size, a shape, a color) of each of the color pattern, person, text, background included in each of the first image 1411, the second image 1413 from the object classification module 1420. For example, the electronic device may obtain a feature related to red, white, blue stripes from the first image 1411 and the second image 1413. The electronic device may identify an attribute that the color pattern is unchangeable, the ratio of the color pattern is unchangeable, and the size of the color pattern is changeable.

According to an embodiment, the electronic device may identify a first object 1431 and a second object 1433 among the objects included in each of the plurality of contents 1410. For example, the electronic device may identify a color pattern 1411a included in the bag of the first image 1411 as the first object 1431. For example, the electronic device may identify a color pattern 1413a included in the muffler of the second image 1413 as the first object 1431. For example, the electronic device may identify the person and the background of the first image 1411 as the second object 1433. For example, the electronic device may identify the person and the background of the second image 1413 as the second object 1433.

According to an embodiment, the electronic device may provide the first object 1431, the second object 1433, and personalized information 1435 to an input prompt generation module 1440. The personalized information 1435 may include information that is obtained based on a second content from an AI model which is trained to obtain a weight value on each of predetermined types from a content. The AI model may correspond to the AI model (for example, the AI model 430 of FIG. 4) described above with reference to FIG. 4, and the AI model (for example, the AI model 720 of FIG. 7) described above with reference to FIG. 7. For example, the personalized information 1435 may include information relevant to the user based on user's interest, preference, need, situation.

According to an embodiment, the electronic device may obtain an input prompt output from the input prompt generation module 1440. The input prompt generation module 1440 may correspond to the input prompt generation module (for example, the input prompt generation module 450 of FIG. 4) described above with reference to FIG. 4 and the input prompt generation module (for example, the input prompt generation module 820 of FIG. 8) described above with reference to FIG. 8.

According to an embodiment, the electronic device may obtain a first input prompt 1451 output from the input prompt generation module 1440, based on the first object 1431 included in the plurality of contents 1410. For example, the electronic device may obtain the first input prompt 1451, based on interrelated first objects among the first objects 1431 included in the plurality of contents 1410. For example, the electronic device may obtain the first input prompt 1451 including the information on the color pattern. For example, the electronic device may obtain the first input prompt 1451 such as “[Pattern] An image that contains a color pattern including stripes of red, white, and blue in sequence, [Pattern attribute] Color pattern being unchangeable, ratio being unchangeable, size being changeable”.

According to an embodiment, the electronic device may obtain a second input prompt 1453 which is output from the input prompt generation module 1440, based on the second object 1433 and the personalized information 1435. For example, the electronic device may obtain the second input prompt 1453 including information on user's interest and preference. For example, the electronic device may obtain the second input prompt 1453 including information on color placement (for example, black & white) preferred by the user. For example, the electronic device may obtain the second input prompt 1453 such as “Create a theme for a mobile terminal in black & white style”.

According to an embodiment, the electronic device may provide the first input prompt 1451 and the second input prompt 1453 to a generative AI model 1460. The generative AI model 1460 may include an AI model that is trained to create a personalized content. The generative AI model 1460 may correspond to the generative AI model (for example, the generative AI model 470 of FIG. 4) described above with reference to FIG. 4. For example, the electronic device may provide the generative AI model 1460 with at least a part of the first input prompt 1451 including information on the key color pattern of the brand. For example, the electronic device may provide the generative AI model 1460 with at least a part of the second input prompt 1453 including information on the color placement preferred by the user. For example, the electronic device may provide the generative AI model 1460 with an input prompt such as “Create a theme for a mobile terminal including a color pattern and black & white style, [Pattern] A color pattern consisting of stripes of red, white, and blue in sequence, [Pattern attribute] Color pattern being unchangeable, ratio being unchangeable, size being changeable”.

According to an embodiment, the electronic device may obtain a third content 1470 output from the generative AI model 1460. For example, the electronic device may obtain the third content 1470 output from the generative AI model 1460 based on at least a part of the first input prompt 1451 and at least a part of the second input prompt 1453. For example, the electronic device may obtain, as the third content 1470, a theme for a mobile terminal including the key color pattern of the brand and the color style preferred by the user.

According to an embodiment, the electronic device may output the third content 1470. For example, the electronic device may output the third content 1470 using at least one of a display, an audio module of the electronic device. For example, the electronic device may transmit the third content 1470 to an external electronic device to output the third content 1470 using at least one of a display, an audio module of the external electronic device.

According to the disclosed embodiments, the electronic device may generate a prompt based on a result of classifying types of objects included in a content and personalized information related to a user, and may apply the prompt to a generative AI model, such that a personalized content may be easily generated and provided to the user.

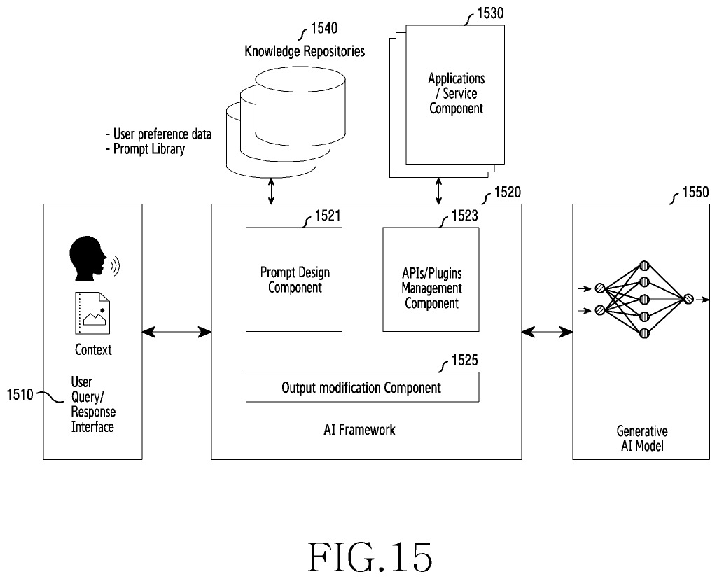

FIG. 15 is a diagram illustrating an example configuration of a system including a generative AI model according to various embodiments.

According to an embodiment, the electronic device of FIGS. 1 to 14 (for example, the electronic device 101 of FIG. 1) may be configured to include at least a part of a user query/response interface 1510, an AI framework 1520, an application/service component 1530, knowledge repositories 1540 or a generative AI model 1550 of FIG. 15. According to an embodiment, at least a part of the user query/response interface 1510, the AI framework 1520, the application/service component 1530, the knowledge repositories 1540 or the generative AI model 1550 of FIG. 15 may be included in an external electronic device (for example, the electronic device 102 of FIG. 1).

Referring to FIG. 15, the user query/response interface 1510 may receive a user input. The user input may be in such a format as a natural language, an image and/or a video. In addition, when the user input is transmitted, context information may also be transmitted. The context information may include a variety of additional information at the time the user input is input. For example, the context information may include information on an application that the user currently uses or location information of the user. In addition, the user input may have a format in which the above-described natural language, image, sound, context information are mixed. In addition, the user input may have a non-natural language format of selecting a menu. The user query/response interface 1510 may output a result of the generative AI system to the user. The output may be in a natural language format or a specific content format and may be provided in the format of an action requested by the user.

The AI framework 1520 may receive the user input and may tune and control components necessary for performing as the user intends based on the user's query.

The user input received at the user query/response interface 1510 may be transmitted to a prompt design component 1521. The prompt design component 1521 may use the user input in generating a prompt appropriate for inputting to a large language model (LLM) or a large multimedia model (LMM). The prompt design component 1521 may be an AI component that uses a machine learning algorithm or a neural network to develop a more enhanced prompt over time. The prompt design component 1521 may generate a prompt by accessing a knowledge component (for example, the knowledge repositories 1540) including user preference data, prompt library, and prompt examples, based on the user input, and may deliver the generated prompt to the LLM or LMM.

An API/Plug-in management component 1523 may perform the role of communicating with external information in response to a request for additional information when the user input is transmitted to the generative AI model as an input. The API/Plug-in management component 1523 may establish a channel to communicate with the outside of am AI interface through an API, and enable access to various data sources (for example, the knowledge repositories 1540) through the established channel. In addition, when a final action of performing not an intermediate result but the user input should be performed in an application or a service, the API/Plug-in management component 1523 may request the corresponding action from the application/service component 1530 through the API. Information obtained from the outside may be used to generate a prompt in the prompt design component 1521 along with the user input, and may be delivered to the generative model as an input.

A refiner component (for example, an output modification component 1525) may minutely tune a result output from the generative model. For example, the refiner component may verify whether the content created through the LLM and/or the LMM is not irrelevant, is biased, or harmful. The refiner component may determine whether the result matches a result desired by the user, and, if an additional process is required, may perform the corresponding process. The refiner component may include a hint for avoiding an undesired additional output, and may provide the hint to the user.

The generative AI model 1550 may refer to an AI neural network that makes data of a new format depending on user input information. The generative AI model 1550 may include a model that generates images and/or a model that generates languages. Representative examples of the model that generates images may be a generative adversarial network (GAN), a variational auto encoder (VAE), a diffusion-based generative model using the VAE and a transformer structure. Representative examples of the model that generates languages may be CHAT-GPT 3, CHAT-GPT 4, which are trained to output the statistically most appropriate output values based on input values. In addition, the LMM that recognizes data of various formats such as texts, images, voices and generate new data corresponding thereto may also be the representative example.

According to an example embodiment, an electronic device may include: at least one processor comprising processing circuitry; and a memory configured to store instructions. At least one processor, individually and/or collectively, may be configured to execute the instructions and to cause the electronic device to: identify a first object corresponding to a primary object and a second object corresponding to an additional object among a plurality of objects included in a first content; obtain personalized information related to a user from a second content; obtain at least one input prompt based on the first object, the second object, and the personalized information; provide, through a user interface, a third content output from a first artificial intelligence (AI) model by providing the at least one input prompt to the first AI model; wherein the third content may include a third object resulting from changing of at least a part of the second object, and the first object; and identify the second object as the additional object which is changeable using the personalized information, based on identification information received in association with the first content.

According to an example embodiment, the second content may include an image captured in a place associated with the user, and the electronic device may identify information related to an object included in the image as a part of the personalized information.

According to an example embodiment, the electronic device may be configured to display the first object updated based on the personalized information on the user interface through the third content.

According to an example embodiment, the electronic device may identify the first object and the second object classified by a second AI model from the first content, by providing the first content to the second AI model.

According to an example embodiment, the at least one input prompt may include a plurality of input prompts including a first input prompt and a second input prompt. The first input prompt may include feature related to the first object, and the second input prompt may include a feature related to the second object and at least a part of the personalized information.

According to an example embodiment, the electronic device may obtain the personalized information output from a third AI model by providing the second content to the third AI model.

According to an example embodiment, the electronic device may obtain the personalized information by identifying a content which is being provided through the electronic device as the second content.

According to an example embodiment, the electronic device may obtain the personalized information by identifying a content to be provided through the electronic device after the third content is provided as the second content.

According to an example embodiment, in a non-transitory computer-readable recording medium having instructions recorded thereon which, when executed by at least one processor, comprising processing circuitry, of an electronic device, individually and/or collectively, cause the electronic device to perform at least one operation. The operations performed by the processor may comprise identifying a first object and a second object designated as being changeable through the electronic device among a plurality of objects included in a first content. The operations performed by the processor may comprise obtaining personalized information related to a user from a second content. The operations performed by the processor may comprise providing a third content created based on the first object, the second object, and the personalized information through a user interface. The third content may include a third object resulting from changing at least a part of the second object based on the personalized information, and the first object.

According to an example embodiment, the second content may include an image captured by the user. Obtaining the personalized information, performed by the processor, may include obtaining a facial region of the user from the image as at least a part of the personalized information.

According to an example embodiment, providing through the user interface, performed by the processor, may include displaying the first object updated based on object information provided by a provider of the first content through the third content.

According to an example embodiment, a method performed by an electronic device, may comprise identifying a first object corresponding to a primary object and a second object corresponding to an additional object among a plurality of objects included in a first content. The method performed by the electronic device may comprise obtaining personalized information related to a user. The method performed by the electronic device may comprise providing a second content created based on the first object, the second object, and the personalized information through a user interface. The second content may include a third object which results from changing of at least a part of the second object, and the first object.

According to an example embodiment, the method performed by the electronic device may further include obtaining the second content by inputting an input prompt generated based on the first object, the second object, and the personalized information to an AI model.

According to an example embodiment, the second content may include the first object that is updated.

According to an example embodiment, the first object may be updated based on object information generated by a provider of the first content.

According to an example embodiment, identifying by the electronic device, may include identifying the first object among the plurality of objects as the primary object, based on identification information received in association with the first content.

According to an example embodiment, identifying by the electronic device, may include identifying, as the additional object, an object that satisfies a designated condition among objects that are included in the plurality of objects and are not identified as the primary object.

According to an example embodiment, the designated condition may be related to types of objects. Identifying, by the electronic device, may include identifying, as the additional object, the second object the type of which is related to a portrait among the plurality of objects.

According to an example embodiment, the personalized information may include information related to a third content which is being provided through the electronic device. The method may include changing the second object to the third object using at least a part of the third content.

The electronic device according to an embodiment of the disclosure may be one of various types of electronic devices. The electronic device may include, for example, a portable communication device (e.g., a smart phone), a computer device, a portable multimedia device, a portable medical device, a camera, a wearable device, a home appliance, or the like. According to an embodiment of the disclosure, the electronic device is not limited to those described above.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to refer to similar or related elements. It is to be understood that a singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in other components. According to an embodiment, one or more of the above-described components or operations may be omitted, or one or more other components or operations may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail May be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
at least one processor comprising processing circuitry; and
a memory storing instructions,
wherein at least one processor, individually and/or collectively, is configured to execute the instructions and to cause the electronic device to:
identify a first object corresponding to a primary object and a second object corresponding to an additional object among a plurality of objects included in a first content;
obtain personalized information related to a user from a second content;
obtain at least one input prompt based on the first object, the second object, and the personalized information; and
provide, through a user interface, a third content output from a first AI model by providing the at least one input prompt to the first AI model,
wherein the third content comprises the first object and a third object in which at least a part of the second object has been changed.

2. The electronic device of claim 1, wherein at least one processor, individually and/or collectively, is configured to cause the electronic device to identify the second object as the additional object which is changeable using the personalized information, based on identification information received in association with the first content.

3. The electronic device of claim 1, wherein the second content comprises an image captured in a place associated with the user, and
wherein at least one processor, individually and/or collectively, is configured to cause the electronic device to identify information related to an object included in the image as a part of the personalized information.

4. The electronic device of claim 1, wherein at least one processor, individually and/or collectively, is configured to cause the electronic device to display the first object updated based on the personalized information on the user interface through the third content.

5. The electronic device of claim 1, wherein at least one processor, individually and/or collectively, is configured to cause the electronic device to identify the first object and the second object classified by a second AI model from the first content, by providing the first content to the second AI model.

6. The electronic device of claim 1, wherein the at least one input prompt comprises a plurality of input prompts comprising a first input prompt and a second input prompt, and
wherein the first input prompt comprises a feature related to the first object and the second input prompt comprises a feature related to the second object and at least a part of the personalized information.

7. The electronic device of claim 1, wherein at least one processor, individually and/or collectively, is configured to cause the electronic device to obtain the personalized information output from a third AI model by providing the second content to the third AI model.

8. The electronic device of claim 1, wherein at least one processor, individually and/or collectively, is configured to cause the electronic device to acquire the personalized information by identifying a content being provided through the electronic device as the second content.

9. The electronic device of claim 1, wherein at least one processor, individually and/or collectively, is configured to cause the electronic device to obtain the personalized information by identifying a content to be provided through the electronic device after the third content is provided as the second content.

10. A non-transitory computer-readable recording medium having instructions recorded thereon which, when executed by at least one processor, comprising processing circuitry, of an electronic device, individually and/or collectively, cause the electronic device to perform at least one operation,
wherein the at least one operation comprises:
identifying a first object and a second object designated as being changeable through the electronic device among a plurality of objects included in a first content;
obtaining personalized information related to a user from a second content; and
providing a third content created based on the first object, the second object, and the personalized information through a user interface,
wherein the third content comprises the first object and a third object in which at least a part of the second object has been changed based on the personalized information.

11. The non-transitory computer-readable recording medium of claim 10, wherein the second content comprises an image captured by the user,
wherein obtaining the personalized information comprises obtaining a facial region of the user from the image as at least a part of the personalized information.

12. The non-transitory computer-readable recording medium of claim 10, wherein providing through the user interface comprises displaying the first object updated based on object information provided by a provider of the first content through the third content.

13. A method performed by an electronic device, the method comprising:
identifying a first object corresponding to a primary object and a second object corresponding to an additional object among a plurality of objects included in a first content;
obtaining personalized information related to a user; and
providing a second content created based on the first object, the second object, and the personalized information through a user interface,
wherein the second content comprises the first object and a third object in which at least a part of the second object has been changed.

14. The method of claim 13, further comprising acquiring the second content by inputting an input prompt generated based on the first object, the second object, and the personalized information to an AI model.

15. The method of claim 13, wherein the second content comprises an updated first object.

16. The method of claim 15, wherein the first object is updated based on object information generated by a provider of the first content.

17. The method of claim 13, wherein identifying comprises identifying the first object among the plurality of objects as the primary object, based on identification information received in association with the first content.

18. The method of claim 13, wherein identifying comprises identifying, as the additional object, an object that satisfies a designated condition among objects included in the plurality of objects and not identified as the primary object.

19. The method of claim 18, wherein the designated condition is related to types of objects, and
wherein identifying comprises identifying, as the additional object, the second object the type of related to a portrait among the plurality of objects.

20. The method of claim 13, wherein the personalized information comprises information related to a third content being provided through the electronic device, and
wherein the method comprises changing the second object to the third object using at least a part of the third content.
